(19) United States
(12) Patent Application Publication
(10) Pub. No.: US 2021/0354722 A1
(43) Pub. Date: Nov. 18, 2021

(54) AUTONOMOUS VEHICLE AND DRIVING CONTROL SYSTEM AND METHOD USING THE SAME

(71) Applicant: LG Electronics Inc., Seoul (KR)

(72) Inventor: Soryoung KIM, Seoul (KR)

(21) Appl. No.: 16/484,735

(22) PCT Filed: May 22, 2019
(86) PCT No.: PCT/KR2019/006107

§ 371 Date: Aug. 8, 2019

(51) Int. Cl. B60W 60/00; G06N 20/00; G01C 21/34; B60W 50/14; G08G 1/0967; G07C 5/08

(52) U.S. Cl. CPC B60W 60/0011; G06N 20/00; G01C 21/3492; B60W 50/14; G05D 1/0027; G07C 5/0808; B60W 2556/50; B60W 2720/10; B60W 2050/146; G08G 1/096725

(57) ABSTRACT

Disclosed are an autonomous vehicle and a driving control system and method using the same. The method of controlling driving a vehicle according to an embodiment of the present invention includes searching for a section occupied by a section service provider in a driving route to a destination; determining whether the vehicle is a subscriber vehicle registered in a section service provided by the section service provider. When the subscriber vehicle drives a section occupied by the section service provider, the subscriber vehicle has a priority in a driving speed, compared to a non-subscriber vehicle. At least one of an autonomous vehicle, a user terminal, and a server of the present invention may be connected to or fused with an Artificial Intelligence (AI) module, a drone (Unmanned Aerial Vehicle (UAV)), a robot, an augmented reality (AR) device, a virtual reality (VR) device, and a device related to a 5G service.

### TECHNICAL FIELD

The present invention relates to an autonomous vehicle, and more particularly, to an autonomous vehicle and a driving control system and method using the same in which a private provider having an operating right of a road included in a driving route to a destination gives a driving priority to a vehicle of a user who pays for a cost according to road use to increase a driving speed of the autonomous vehicle.

### BACKGROUND ART

Autonomous vehicles are capable of driving themselves without a driver's intervention. Many companies have already entered an autonomous vehicle project and engaged in research and development.

Autonomous vehicles can support an automatic parking service that finds and parks an empty space without a driver's intervention.

### DISCLOSURE

### Technical Problem

A navigation system may reflect a real time traffic situation to guide a driving route to a destination. Such a driving route guide method has a problem that guides the same driving route, for example, a quick way or a free road to all vehicles advancing to the same destination. When many vehicles use the same road, a traffic volume of the road may increase to cause a traffic jam.

In case of a serious traffic jam, a driving time may be delayed even in a driving route recommended as a minimum driving time by the navigation system. Therefore, when a driving route recommended by an existing navigation system is used, there is almost no driving time shortening effect at a time zone of a heavy traffic jam.

An object of the present invention is to solve the above-described needs and/or problems.

The object of the present invention is not limited to the above-described objects and the other objects will be understood by those skilled in the art from the following description.

### Technical Solution

An autonomous vehicle according to at least one embodiment of the present invention for achieving the above object includes a navigation system for generating a driving route between a starting point and a destination and matching traffic volume information of each section of the driving route, information of a section service provider, and cost information received from an external server on the driving route to display the information in a display; and a controller for controlling a speed of other vehicle at a section occupied by the section service provider through communication between vehicles.

A driving control system according to at least one embodiment of the present invention includes a server for receiving an input of starting point and destination information to generate traffic volume information of each divided section, information of a section service provider, and cost information at a road section of a driving route to the destination; and a navigation system for generating a driving route between the starting point and the destination and matching the traffic volume information of each section, the information of the section service provider, and the cost information received from the server on the driving route to display the information in a display, and a controller for controlling a speed of other vehicle at a section occupied by the section service provider through communication between vehicles.

A method of controlling driving of a vehicle according to at least one embodiment of the present invention includes searching for a section occupied by a section service provider in a driving route to a destination; determining whether the vehicle is a subscriber vehicle registered in a section service provided by the section service provider; and having, by the subscriber vehicle, a priority in a driving speed, compared to a non-subscriber vehicle when the subscriber vehicle drives a section occupied by the section service provider.

### Advantageous Effects

According to the present invention, investment for road construction of an autonomous vehicle related company can be promoted through an auction of each section and time zone of a road.

According to the present invention, by traffic volume distribution using an idle road, a driving time of a vehicle can be shortened, and service satisfaction can be improved through traffic quality management of a section service provider. According to the present invention, when a user inputs a destination, various driving routes to the destination, a traffic volume at each section of each driving route, a section service provider, cost information and the like can be provided.

According to the present invention, by exerting a driving priority received from a section service provider, a driving speed of a predetermined level or more can be guaranteed at a corresponding section.

The effects of the present invention are not limited to the above-described effects and the other effects will be understood by those skilled in the art from the description of claims.

### DESCRIPTION OF DRAWINGS

FIG. 1 illustrates an example of a basic operation of an autonomous vehicle and a 5G network in a 5G communication system.

FIG. 2 illustrates an example of an application operation of an autonomous vehicle and a 5G network in a 5G communication system.

FIGS. 3 to 6 illustrate an example of an operation of an autonomous vehicle using 5G communication.

FIG. 7 is a diagram illustrating an external shape of a vehicle according to an embodiment of the present invention.

FIG. 8 is a diagram illustrating a vehicle when viewed in various angles of the outside according to an embodiment of the present invention.

FIGS. 9 and 10 are diagrams illustrating the inside of a vehicle according to an embodiment of the present invention.

FIGS. 11 and 12 are diagrams illustrating examples of objects related to driving of a vehicle according to an embodiment of the present invention;

FIG. 13 is a block diagram illustrating in detail a vehicle according to an embodiment of the present invention;

FIG. 14 is a diagram illustrating V2X communication.

FIG. 15 is a diagram illustrating a driving control system according to an embodiment of the present invention.

FIG. 16 is a flowchart illustrating selection of a section service provider of a private road, a section traffic quality, and user satisfaction evaluation.

FIG. 17 is a message flow diagram illustrating transmitting and receiving messages between a user and a server in a driving control system.

FIG. 18 is a flowchart illustrating a method of controlling driving according to an embodiment of the present invention.

FIG. 19 is a flowchart illustrating a method of guiding an existing route and a changeable route while a vehicle drives.

FIG. 20 is a diagram illustrating an example of showing a traffic volume, company information, a cost, and an estimated passing time of each section on a map.

FIG. 21 is a flowchart illustrating an example of giving a driving priority to a subscriber vehicle in a private road.

FIG. 22 is a flowchart illustrating an example in which a driving priority of subscriber vehicle is exerted through communication between vehicles.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

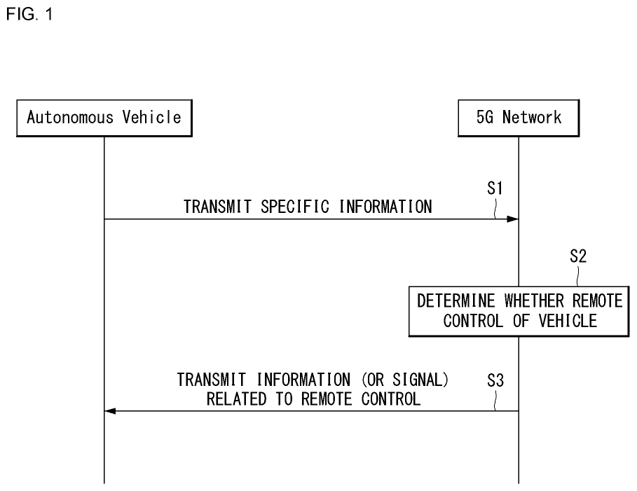

FIG. 1 illustrates an example of a basic operation of an autonomous vehicle and a 5G network in a 5G communication system.

The autonomous vehicle transmits specific information to the 5G network (S1).

The specific information may include autonomous driving related information.

The autonomous driving related information may be information directly related to driving control of the vehicle. For example, the autonomous driving related information may include at least one of object data indicating an object at a periphery of the vehicle, map data, vehicle status data, vehicle location data, and driving plan data.

The autonomous driving related information may further include service information necessary for autonomous driving. For example, the specific information may include information on a destination and a safety grade of the vehicle input through a user terminal.

The 5G network may determine whether the remote control of the vehicle (S2).

Here, the 5G network may include a server or a module for performing the autonomous driving related remote control.

The 5G network may transmit information (or signal) related to the remote control to the autonomous vehicle (S3).

As described above, information related to the remote control may be a signal directly applied to the autonomous vehicle and may further include service information required for autonomous driving. In an embodiment of the present invention, the autonomous vehicle may receive service information such as a danger section and each section insurance selected on a driving route through a server connected to the 5G network to provide a service related to autonomous driving.

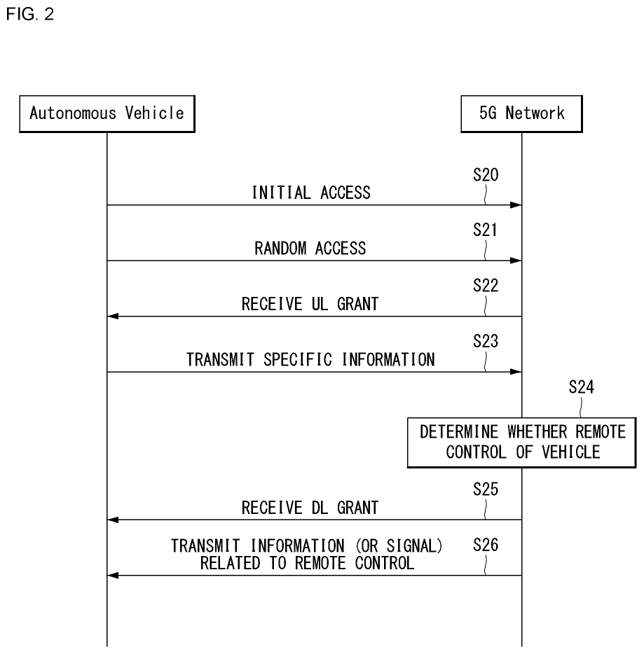

Hereinafter, in FIGS. 2 to 6, in order to provide an insurance service that may be applied to each section in an autonomous driving process according to an embodiment of the present invention, a required process (e.g., an initial access procedure between the vehicle and the 5G network) for 5G communication between the autonomous vehicle and the 5G network is described.

FIG. 2 illustrates an example of an application operation of an autonomous vehicle and a 5G network in a 5G communication system.

The autonomous vehicle performs an initial access procedure with the 5G network (S20).

The initial access procedure includes a process for obtaining system information and cell search for obtaining a downlink (DL) operation.

The autonomous vehicle performs a random access procedure with the 5G network (S21).

The random access process includes preamble transmission and random access response reception processes for uplink (UL) synchronization acquisition or UL data transmission. The 5G network transmits UL grant for scheduling transmission of specific information to the autonomous vehicle (S22).

The UL grant reception includes a process of receiving time/frequency resource scheduling for transmission of UL data to the 5G network.

The autonomous vehicle transmits specific information to the 5G network based on the UL grant (S23).

The 5G network determines whether the remote control of the vehicle (S24).

In order to receive a response to specific information from the 5G network, the autonomous vehicle receives DL grant through a physical downlink control channel (S25).

The 5G network transmits information (or signal) related to the remote control to the autonomous vehicle based on the DL grant (S26).

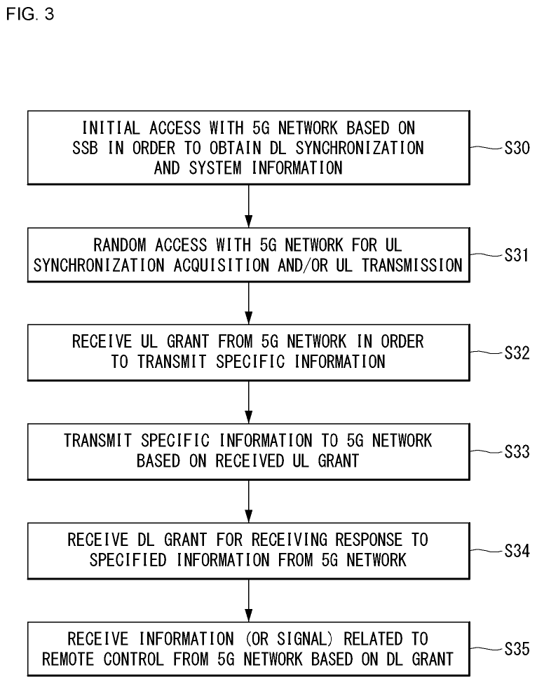

FIG. 3 illustrates an example in which an initial access process and/or a random access process and a DL grant reception process of an autonomous vehicle and 5G communication are coupled through processes of S20 to S26, but the present invention is not limited thereto.

For example, the initial access process and/or the random access process may be performed through the processes of S20, S22, S23, and S24. Further, for example, the initial access process and/or the random access process may be performed through processes of S21, S22, S23, S24, and S26. Further, a coupling process of an AI operation and a DL grant reception process may be performed through S23, S24, S25, and S26.

Further, FIG. 2 illustrates an autonomous vehicle operation through S20 to S26, and the present invention is not limited thereto.

For example, in the autonomous vehicle operation, S20, S21, S22, and S25 may be selectively coupled to S23 and S26 and be operated. Further, for example, the autonomous vehicle operations may be configured with S21, S22, S23, and S26. Further, for example, the autonomous vehicle operations may be configured with S20, S21, S23, and S26. Further, for example, the autonomous vehicle operations may be configured with S22, S23, S25, and S26.

FIGS. 3 to 6 illustrate an example of an autonomous vehicle operation using 5G communication.

Referring to FIG. 3, in order to obtain DL synchronization and system information, the autonomous vehicle including an autonomous module performs an initial access procedure with the 5G network based on a synchronization signal block (SSB) (S30).

The autonomous vehicle performs a random access procedure with the 5G network for UL synchronization acquisition and/or UL transmission (S31).

In order to transmit specific information, the autonomous vehicle receives UL grant from the 5G network (S32).

The autonomous vehicle transmits specific information to the 5G network based on the UL grant (S33).

The autonomous vehicle receives DL grant for receiving a response to the specified information from the 5G network (S34).

The autonomous vehicle receives information (or signal) related to the remote control from the 5G network based on DL grant (S35).

A Beam Management (BM) process may be added to S30, a beam failure recovery process related to physical random access channel (PRACH) transmission may be added to S31, a QCL relationship may be added to S32 in relation to a beam reception direction of a physical downlink control channel (PDCCH) including UL grant, and a QCL relationship may be added to S33 in relation to a beam transmission direction of a physical uplink control channel (PUCCH)/physical uplink shared channel (PUSCH) including specific information. Further, a QCL relationship may be added to S34 in relation to a beam reception direction of the PDCCH including DL grant.

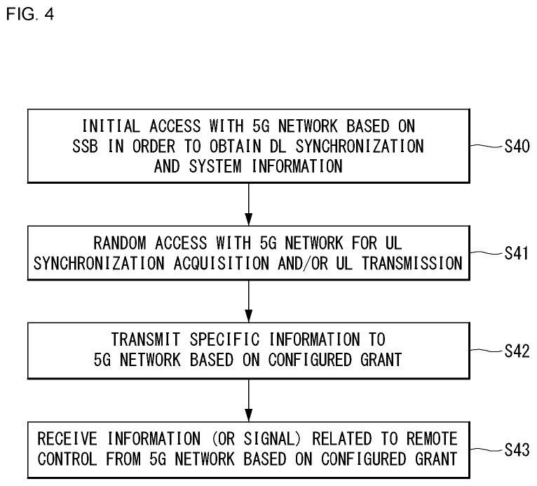

Referring to FIG. 4, in order to obtain DL synchronization and system information, the autonomous vehicle performs an initial access procedure with the 5G network based on the SSB (S40).

The autonomous vehicle performs a random access procedure with the 5G network for UL synchronization acquisition and/or UL transmission (S41).

The autonomous vehicle transmits specific information to the 5G network based on configured grant (S42).

The autonomous vehicle receives information (or signal) related to the remote control from the 5G network based on the configured grant (S43).

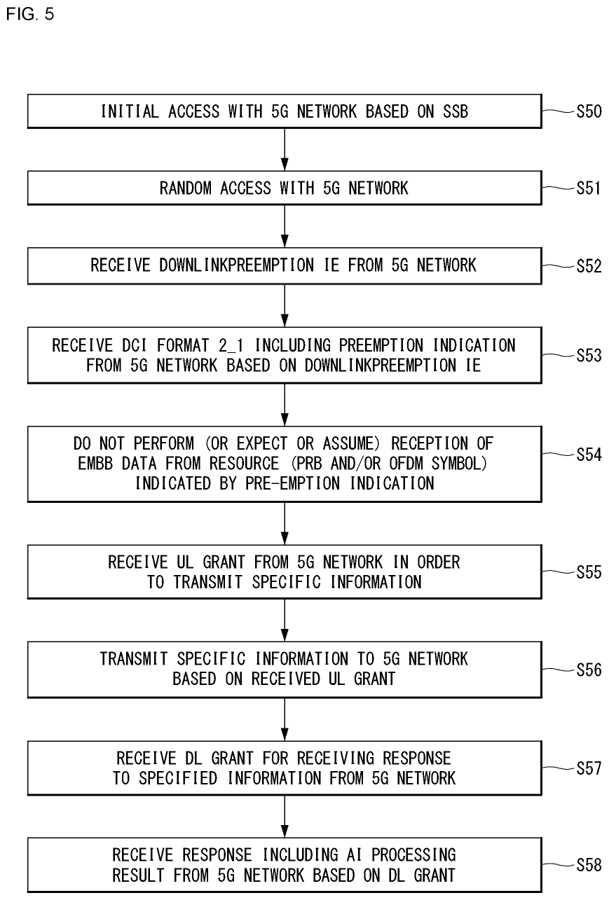

Referring to FIG. 5, in order to obtain DL synchronization and system information, the autonomous vehicle performs an initial access procedure with the 5G network based on the SSB (S50).

The autonomous vehicle performs a random access procedure with the 5G network for UL synchronization acquisition and/or UL transmission (S51).

The autonomous vehicle receives DownlinkPreemption IE from the 5G network (S52).

The autonomous vehicle receives a DCI format 2_1 including a preemption indication from the 5G network based on the DownlinkPreemption IE (S53).

The autonomous vehicle does not perform (or expect or assume) reception of eMBB data from a resource (PRB and/or OFDM symbol) indicated by the pre-emption indication (S54).

In order to transmit specific information, the autonomous vehicle receives UL grant from the 5G network (S55).

The autonomous vehicle transmits specific information to the 5G network based on the UL grant (S56).

The autonomous vehicle receives DL grant for receiving a response to the specified information from the 5G network (S57).

The autonomous vehicle receives information (or signal) related to the remote control from the 5G network based on DL grant (S58).

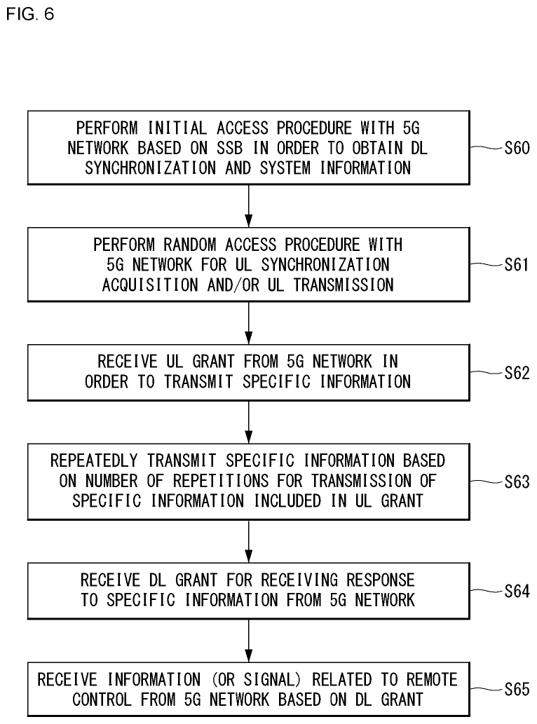

Referring to FIG. 6, in order to obtain DL synchronization and system information, the autonomous vehicle performs an initial access procedure with the 5G network based on the SSB (S60).

The autonomous vehicle performs a random access procedure with the 5G network for UL synchronization acquisition and/or UL transmission (S61).

In order to transmit specific information, the autonomous vehicle receives UL grant from the 5G network (S62).

The UL grant includes information on the number of repetitions of transmission of the specific information, and the specific information is repeatedly transmitted based on the information on the repetition number (S63).

The autonomous vehicle transmits specific information to the 5G network based on the UL grant.

Repeated transmission of specific information is performed through frequency hopping, first specific information may be transmitted in a first frequency resource, and second specific information may be transmitted in a second frequency resource.

The specific information may be transmitted through a narrowband of 6 resource blocks (RB) or 1RB.

The autonomous vehicle receives DL grant for receiving a response to specific information from the 5G network (S64).

The autonomous vehicle receives information (or signal) related to the remote control from the 5G network based on DL grant (S65).

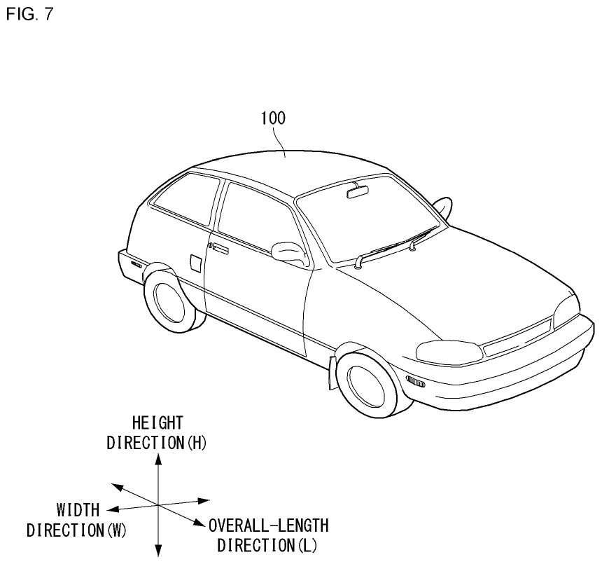

The foregoing 5G communication technology may be applied in combination with methods proposed in the present specification to be described later in FIGS. 7 to 24 or may be supplemented for specifying or for clearly describing technical characteristics of the methods proposed in the present specification.

A vehicle described in the present specification may be connected to an external server through a communication network and move along a preset route without a driver's intervention using autonomous driving technology. The vehicle of the present invention may be implemented into an internal combustion vehicle having an engine as a power source, a hybrid vehicle having an engine and an electric motor as a power source, and an electric vehicle having an electric motor as a power source.

In the following embodiments, a bidding participating company is a provider bidding in an auction for a time and section of a private road. A sectional service provider is a provider who bids an auction for a time and section to successfully bid and to obtain a possessory right for a time and section of a private road. A management company may provide a traffic volume management service of a private road section occupied by the company and give a driving priority to a subscriber who subscribes to the service and who pays for service use.

A section service means a driving speed guaranteeing service provided by a section service provider. A user who registers a section service is referred to as a subscriber. A user who does not register a section service is referred to as a non-subscriber.

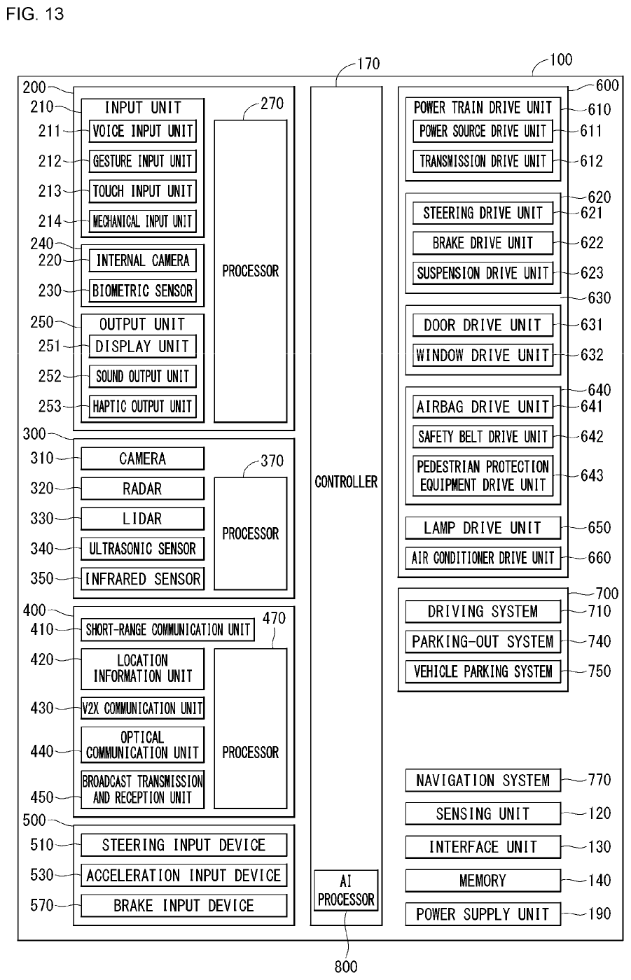

A user may be a driver or a passenger of a vehicle. A user terminal may be a terminal, for example, a smart phone in which a user may carry and that may transmit location information and that may transmit and receive a signal to and from a vehicle and/or an external device (or server) through a communication network. Further, the user terminal may be an In-Vehicle Infotainment (IVI) system of the vehicle illustrated in FIG. 13.

At least one of an autonomous vehicle, a user terminal, and a server of the present invention may be connected to or fused with an Artificial Intelligence (AI) module, a drone (Unmanned Aerial Vehicle (UAV)), a robot, an augmented reality (AR) device, a virtual reality (VR) device, and a device related to a 5G service.

For example, the autonomous vehicle may operate in connection with at least one artificial intelligence (AI) and robot included in the vehicle.

For example, the vehicle may mutually operate with at least one robot. The robot may be an Autonomous Mobile Robot (AMR). The mobile robot is capable of moving by itself to be free to move, and has a plurality of sensors for avoiding obstacles during driving to drive while avoiding obstacles. The moving robot may be a flight type robot (e.g., drone) having a flying device. The moving robot may be a wheel type robot having at least one wheel and moving through a rotation of the wheel. The moving robot may be a leg robot having at least one leg and moving using the leg.

The robot may function as a device that supplements convenience of a vehicle user. For example, the robot may perform a function of moving baggage loaded in the vehicle to a final destination of the user. For example, the robot may perform a function of guiding a route to a final destination to a user who gets off the vehicle. For example, the robot may perform a function of transporting a user who gets off the vehicle to a final destination.

At least one electronic device included in the vehicle may communicate with the robot through a communication device.

At least one electronic device included in the vehicle may provide data processed in at least one electronic device included in the vehicle to the robot. For example, at least one electronic device included in the vehicle may provide at least one of object data indicating an object at a periphery of the vehicle, map data, vehicle status data, vehicle location data, and driving plan data to the robot.

At least one electronic device included in the vehicle may receive data processed in the robot from the robot. At least one electronic device included in the vehicle may receive at least one of sensing data generated in the robot, object data, robot status data, robot location data, and movement plan data of the robot.

At least one electronic device included in the vehicle may generate a control signal based on data received from the robot. For example, at least one electronic device included in the vehicle may compare information on the object generated in the object detecting device and information on an object generated by the robot and generate a control signal based on a comparison result. At least one electronic device included in the vehicle may generate a control signal so that interference does not occur between a moving route of the vehicle and a moving route of the robot.

At least one electronic device included in the vehicle may include a software module or a hardware module (hereinafter, artificial intelligence module) that implements artificial intelligence (AI). At least one electronic device included in the vehicle may use data that input the obtained data to the artificial intelligence module and that are output from the artificial intelligence module.

The AI module may perform machine learning of input data using at least one artificial neural network (ANN). The AI module may output driving plan data through machine learning of the input data.

At least one electronic device included in the vehicle may generate a control signal based on data output from the AI module.

According to an embodiment, at least one electronic device included in the vehicle may receive data processed by artificial intelligence from an external device through the communication device. At least one electronic device included in the vehicle may generate a control signal based on data processed by artificial intelligence.

Hereinafter, various embodiments of the present specification will be described in detail with reference to the attached drawings.

Referring to FIGS. 7 to 13, an overall length means a length from the front to the rear of a vehicle 100, a width means a width of the vehicle 100, and a height means a length from a lower portion of a wheel to a loop of the vehicle 100. In FIG. 7, an overall length direction L means a direction to be the basis of overall length measurement of the vehicle 100, a width direction W means a direction to be the basis of width measurement of the vehicle 100, and a height direction H means a direction to be the basis of height measurement of the vehicle 100. In FIGS. 7 to 12, the vehicle is illustrated in a sedan type, but it is not limited thereto.

The vehicle 100 may be remotely controlled by an external device. The external device may be interpreted as a server. When it is determined that the remote control of the vehicle 100 is required, the server may perform the remote control of the vehicle 100.

A driving mode of the vehicle 100 may be classified into a manual mode, an autonomous mode, or a remote control mode according to a subject of controlling the vehicle 100. In the manual mode, the driver may directly control the vehicle to control vehicle driving. In the autonomous mode, a controller 170 and an operation system 700 may control driving of the vehicle 100 without intervention of the driver. In the remote control mode, the external device may control driving of the vehicle 100 without intervention of the driver.

The user may select one of an autonomous mode, a manual mode, and a remote control mode through a user interface device 200.

The vehicle 100 may be automatically switched to one of an autonomous mode, a manual mode, and a remote control mode based on at least one of driver status information, vehicle driving information, and vehicle status information.

The driver status information may be generated through the user interface device 200 to be provided to the controller 170. The driver status information may be generated based on an image and biometric information on the driver detected through an internal camera 220 and a biometric sensor 230. For example, the driver status information may include a line of sight, a facial expression, and a behavior of the driver obtained from an image obtained through the internal camera 220 and driver location information. The driver status information may include biometric information of the user obtained through the biometric sensor 230. The driver status information may represent a direction of a line of sight of the driver, whether drowsiness of the driver, and the driver's health and emotional status.

The vehicle driving information may include location information of the vehicle 100, posture information of the vehicle 100, information on another vehicle OB11 received from the another vehicle OB11, information on a driving route of the vehicle 100, or navigation information including map information.

The vehicle driving information may include a current location of the vehicle 100 on a route to a destination, a type, a location, and a movement of an object existing at a periphery of the vehicle 100, and whether there is a lane detected at a periphery of the vehicle 100. Further, the vehicle driving information may represent driving information of another vehicle 100, a space in which stop is available at a periphery of the vehicle 100, a possibility in which the vehicle and the object may collide, pedestrian or bike information detected at a periphery of the vehicle 100, road information, a signal status at a periphery of the vehicle 100, and a movement of the vehicle 100.

The vehicle driving information may be generated through connection with at least one of an object detection device 300, a communication device 400, a navigation system 770, a sensing unit 120, and an interface unit 130 to be provided to the controller 170.

The vehicle status information may be information related to a status of various devices provided in the vehicle 100. For example, the vehicle status information may include information on a charge status of the battery, information on an operating status of the user interface device 200, the object detection device 300, the communication device 400, a maneuvering device 500, a vehicle drive device 600, and an operation system 700, and information on whether there is abnormality in each device.

The vehicle status information may represent whether a Global Positioning System (GPS) signal of the vehicle 100 is normally received, whether there is abnormality in at least one sensor provided in the vehicle 100, or whether each device provided in the vehicle 100 normally operates.

A control mode of the vehicle 100 may be switched from a manual mode to an autonomous mode or a remote control mode, from an autonomous mode to a manual mode or a remote control mode, or from a remote control mode to a manual mode or an autonomous mode based on object information generated in the object detection device 300.

The control mode of the vehicle 100 may be switched from a manual mode to an autonomous mode or from an autonomous mode to a manual mode based on information received through the communication device 400.

The control mode of the vehicle 100 may be switched from a manual mode to an autonomous mode or from an autonomous mode to a manual mode based on information, data, and a signal provided from an external device.

When the vehicle 100 is driven in an autonomous mode, the vehicle 100 may be driven under the control of the operation system 700. In the autonomous mode, the vehicle 100 may be driven based on information generated in the driving system 710, the parking-out system 740, and the parking system 750.

When the vehicle 100 is driven in a manual mode, the vehicle 100 may be driven according to a user input that is input through the maneuvering device 500.

When the vehicle 100 is driven in a remote control mode, the vehicle 100 may receive a remote control signal transmitted by the external device through the communication device 400. The vehicle 100 may be controlled in response to the remote control signal.

Referring to FIG. 13, the vehicle 100 may include the user interface device 200, the object detection device 300, the communication device 400, the maneuvering device 500, a vehicle drive device 600, the operation system 700, a navigation system 770, a sensing unit 120, an interface 130, a memory 140, a controller 170, and a power supply unit 190.

In addition to the components illustrated in FIG. 13, other components may be further included or some components may be omitted.

The user interface device 200 is provided to support communication between the vehicle 100 and a user. The user interface device 200 may receive a user input, and provide information generated in the vehicle 100 to the user. The vehicle 100 may enable User Interfaces (UI) or User Experience (UX) through the user interface device 200.

The user interface device 200 may include an input unit 210, an internal camera 220, a biometric sensor 230, an output unit 250, and a processor 270.

The input unit 210 is configured to receive a user command from a user, and data collected in the input unit 210 may be analyzed by the processor 270 and then recognized as a control command of the user.

The input unit 210 may be disposed inside the vehicle 100. For example, the input unit 210 may be disposed in a region of a steering wheel, a region of an instrument panel, a region of a seat, a region of each pillar, a region of a door, a region of a center console, a region of a head lining, a region of a sun visor, a region of a windshield, or a region of a window.

The input unit 210 may include a voice input unit 211, a gesture input unit 212, a touch input unit 213, and a mechanical input unit 214.

The voice input unit 211 may convert a voice input of a user into an electrical signal. The converted electrical signal may be provided to the processor 270 or the controller 170. The voice input unit 211 may include one or more microphones.

The gesture input unit 212 may convert a gesture input of a user into an electrical signal. The converted electrical signal may be provided to the processor 270 or the controller 170.

The gesture input unit 212 may sense the 3D gesture input. To this end, the gesture input unit 212 may include a plurality of light emitting units for outputting infrared light, or a plurality of image sensors.

The gesture input unit 212 may sense the 3D gesture input by employing a Time of Flight (TOF) scheme, a structured light scheme, or a disparity scheme.

The touch input unit 213 may convert a user's touch input into an electrical signal. The converted electrical signal may be provided to the processor 270 or the controller 170. The touch input unit 213 may include a touch sensor for sensing a touch input of a user. The touch input unit 210 may be formed integral with a display unit 251 to implement a touch screen. The touch screen may provide an input interface and an output interface between the vehicle 100 and the user.

The mechanical input unit 214 may include at least one selected from among a button, a dome switch, a jog wheel, and a jog switch. An electrical signal generated by the mechanical input unit 214 may be provided to the processor 270 or the controller 170. The mechanical input unit 214 may be located on a steering wheel, a center fascia, a center console, a cockpit module, a door, etc.

An occupant sensor 240 may detect an occupant in the vehicle 100. The occupant sensor 240 may include the internal camera 220 and the biometric sensor 230.

The internal camera 220 may acquire images of the inside of the vehicle 100. The processor 270 may sense a user's state based on the images of the inside of the vehicle 100.

The processor 270 may acquire information on the eye gaze, the face, the behavior, the facial expression, and the location of the user from an image of the inside of the vehicle 100. The processor 270 may sense a gesture of the user from the image of the inside of the vehicle 100. The processor 270 may provide the driver state information to the controller 170,

The biometric sensor 230 may acquire biometric information of the user. The biometric sensor 230 may include a sensor for acquire biometric information of the user, and may utilize the sensor to acquire finger print information, heart rate information, brain wave information etc. of the user. The biometric information may be used to authenticate a user or determine the user's condition.

The processor 270 may determine a driver's state based on the driver's biometric information. The driver state information may indicate whether the driver is in faint, dozing off, excited, or in an emergency situation. The processor 270 may provide the driver state information, acquired based on the driver's biometric information, to the controller 170.

The output unit 250 is configured to generate a visual, audio, or tactile output. The output unit 250 may include at least one selected from among a display unit 251, a sound output unit 252, and a haptic output unit 253.

The display unit 251 may display an image signal including various types of information. The display unit 251 may include at least one selected from among a Liquid Crystal Display (LCD), a Thin Film Transistor-Liquid Crystal Display (TFT LCD), an Organic Light-Emitting Diode (OLED), a flexible display, a 3D display, and an e-ink display.

The display unit 251 may form an inter-layer structure together with the touch input unit 213 to implement a touch screen. The display unit 251 may be implemented as a Head Up Display (HUD). When implemented as a HUD, the display unit 251 may include a projector module in order to output information through an image projected on a windshield or a window.

The display unit 251 may include a transparent display. The transparent display may be attached on the windshield or the window. In order to achieve the transparency, the transparent display may include at least one selected from among a transparent Thin Film Electroluminescent (TFEL) display, an Organic Light Emitting Diode (OLED) display, a transparent Liquid Crystal Display (LCD), a transmissive transparent display, and a transparent Light Emitting Diode (LED) display. The transparency of the transparent display may be adjustable.

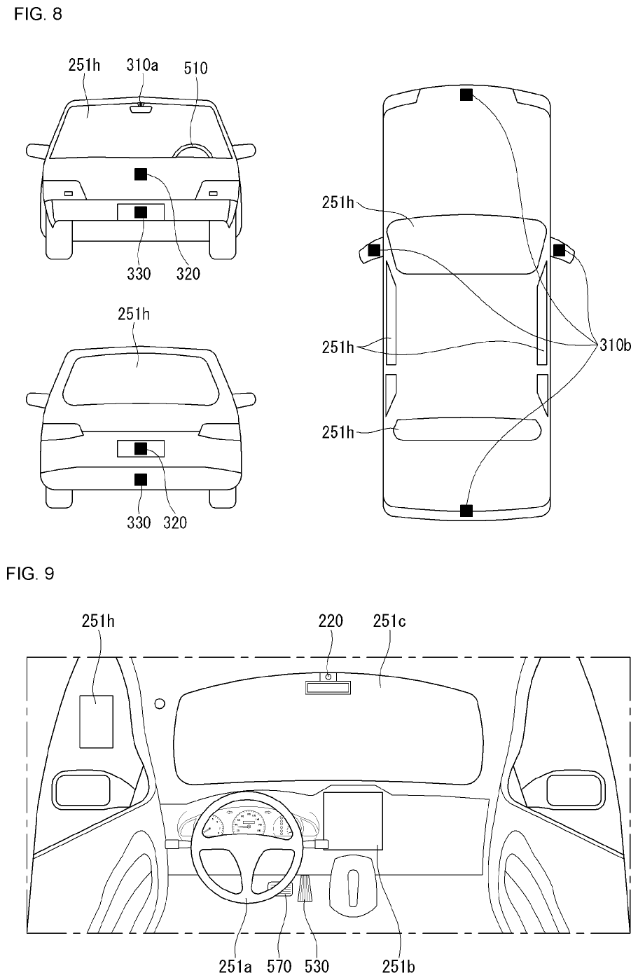

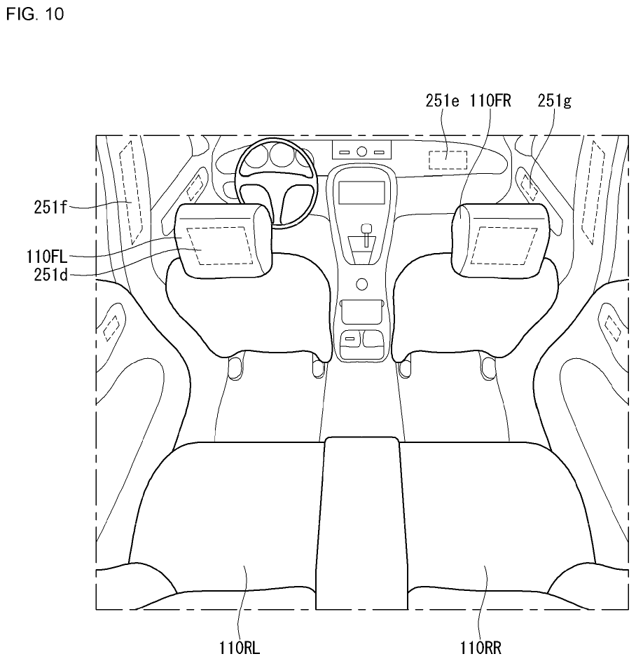

The display unit 251 may include a plurality of displays 251a to 251g as shown in FIGS. 8 and 10. The display unit 251 may be disposed in a region 251a of a steering wheel, a region 251b or 251e of an instrument panel, a region 251d of a seat, a region 251f of each pillar, a region 251g of a door, a region of a center console, a region of a head lining, a region of a sun visor, a region 251c of a windshield, or a region 251h of a window. The display 251h disposed in the window may be disposed in each of the front window, the rear window, and the side window of the vehicle 100.

The sound output unit 252 converts an electrical signal from the processor 270 or the controller 170 into an audio signal, and outputs the audio signal. To this end, the sound output unit 252 may include one or more speakers.

The haptic output unit 253 generates a tactile output. For example, the haptic output unit 253 may operate to vibrate a steering wheel, a safety belt, and seats 110FL, 110FR, 110RL, and 110RR so as to allow a user to recognize the output.

The processor 270 may control the overall operation of each unit of the user interface device 200. In a case where the user interface device 200 does not include the processor 270, the user interface device 200 may operate under control of the controller 170 or a processor of a different device inside the vehicle 100.

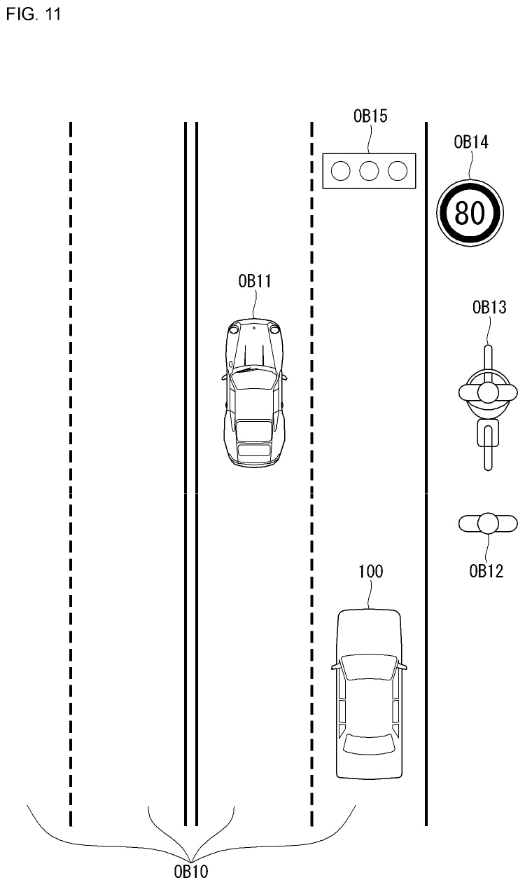

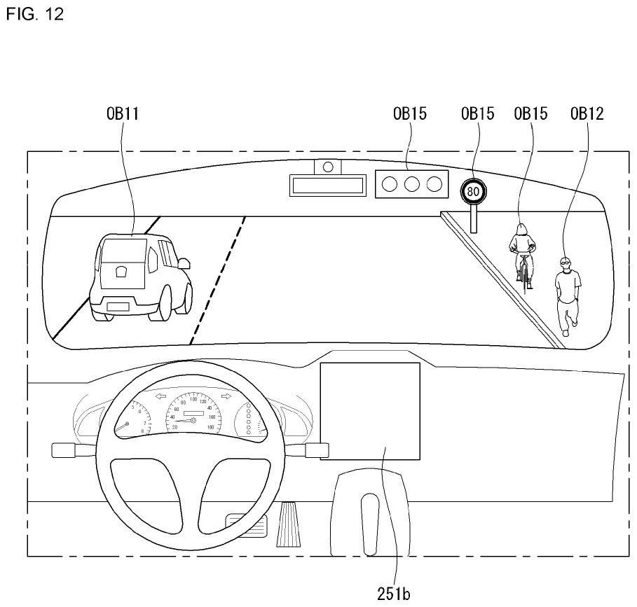

The object detection device 300 is configured to detect an object outside the vehicle 100. The object may include various objects related to travelling of the vehicle 100. For example, referring to FIGS. 11 and 12, an object o may include a lane OB10, a nearby vehicle OB11, a pedestrian OB12, a two-wheeled vehicle OB13, a traffic sign OB14 and OB15, a light, a road, a structure, a bump, a geographical feature, an animal, etc.

The lane OB10 may be a lane in which the vehicle 100 is traveling, a lane next to the lane in which the vehicle 100 is traveling, or a lane in which a different vehicle is travelling from the opposite direction. The lane OB10 may include left and right lines that define the lane.

The nearby vehicle OB11 may be a vehicle that is travelling in the vicinity of the vehicle 100. The nearby vehicle OB11 may be a vehicle within a predetermined distance from the vehicle 100. For example, the nearby vehicle OB11 may be a vehicle that is travelling ahead or behind the vehicle 100.

The pedestrian OB12 may be a person in the vicinity of the vehicle 100. The pedestrian OB12 may be a person within a predetermined distance from the vehicle 100. For example, the pedestrian OB12 may be a person on a sidewalk or on the roadway.

The two-wheeled vehicle OB13 is a vehicle that is located in the vicinity of the vehicle 100 and moves with two wheels. The two-wheeled vehicle OB13 may be a vehicle that has two wheels within a predetermined distance from the vehicle 100. For example, the two-wheeled vehicle OB13 may be a motorcycle or a bike on a sidewalk or the roadway.

The traffic sign may include a traffic light OB15, a traffic sign plate OB14, and a pattern or text painted on a road surface.

The light may be light generated by a lamp provided in the nearby vehicle. The light may be light generated by a street light. The light may be solar light.

The road may include a road surface, a curve, and slopes, such as an upward slope and a downward slope.

The structure may be a body located around the road in the state of being fixed onto the ground. For example, the structure may include a streetlight, a roadside tree, a building, a bridge, a traffic light, a curb, a guardrail, etc.

The geographical feature may include a mountain and a hill.

The object may be classified as a movable object or a stationary object. The movable object may include a nearby vehicle and a pedestrian. The stationary object may include a traffic sign, a road, and a fixed structure.

The object detection device 300 may include a camera 310, a radar 320, a lidar 330, an ultrasonic sensor 340, an infrared sensor 350, and a processor 370.

The camera 310 may photograph an external environment of the vehicle 100 and outputs a video signal showing the external environment of the vehicle 100. The camera 310 may photograph a pedestrian around the vehicle 100.

The camera 310 may be located at an appropriate position outside the vehicle 100 in order to acquire images of the outside of the vehicle 100. The camera 310 may be a mono camera, a stereo camera 310a, an Around View Monitoring (AVM) camera 310b, or a 360-degree camera.

The camera 310 may be disposed near a front windshield in the vehicle 100 in order to acquire images of the front of the vehicle 100. The camera 310 may be disposed around a front bumper or a radiator grill. The camera 310 may be disposed near a rear glass in the vehicle 100 in order to acquire images of the rear of the vehicle 100. The camera 310 may be disposed around a rear bumper, a trunk, or a tailgate. The camera 310 may be disposed near at least one of the side windows in the vehicle 100 in order to acquire images of the side of the vehicle 100. The camera 310 may be disposed around a side mirror, a fender, or a door. The camera 310 may provide an acquired image to the processor 370.

The radar 320 may include an electromagnetic wave transmission unit and an electromagnetic wave reception unit. The radar 320 may be realized as pulse radar or continuous wave radar depending on the principle of emission of an electronic wave. The radar 320 may be realized as Frequency Modulated Continuous Wave (FMCW) type radar or Frequency Shift Keying (FSK) type radar depending on the waveform of a signal.

The radar 320 may detect an object through the medium of an electromagnetic wave by employing a time of flight (TOF) scheme or a phase-shift scheme, and may detect a location of the detected object, the distance to the detected object, and the speed relative to the detected object. The radar 320 may be located at an appropriate position outside the vehicle 100 in order to sense an object located in front of the vehicle 100, an object located to the rear of the vehicle 100, or an object located to the side of the vehicle 100.

The lidar 330 may include a laser transmission unit and a laser reception unit. The lidar 330 may be implemented by the TOF scheme or the phase-shift scheme. The lidar 330 may be implemented as a drive type lidar or a non-drive type lidar. When implemented as the drive type lidar, the lidar 300 may rotate by a motor and detect an object in the vicinity of the vehicle 100. When implemented as the non-drive type lidar, the lidar 300 may utilize a light steering technique to detect an object located within a predetermined distance from the vehicle 100. The vehicle 100 may include a plurality of non-driven type lidar 330.

The lidar 330 may detect an object through the medium of laser light by employing the TOF scheme or the phase-shift scheme, and may detect a location of the detected object, the distance to the detected object, and the speed relative to the detected object. The lidar 330 may be located at an appropriate position outside the vehicle 100 in order to sense an object located in front of the vehicle 100, an object located to the rear of the vehicle 100, or an object located to the side of the vehicle 100.

The ultrasonic sensor 340 may include an ultrasonic wave transmission unit and an ultrasonic wave reception unit. The ultrasonic sensor 340 may detect an object based on an ultrasonic wave, and may detect a location of the detected object, the distance to the detected object, and the speed relative to the detected object. The ultrasonic sensor 340 may be located at an appropriate position outside the vehicle 100 in order to detect an object located in front of the vehicle 100, an object located to the rear of the vehicle 100, and an object located to the side of the vehicle 100.

The infrared sensor 350 may include an infrared light transmission unit and an infrared light reception unit. The infrared sensor 340 may detect an object based on infrared light, and may detect a location of the detected object, the distance to the detected object, and the speed relative to the detected object. The infrared sensor 350 may be located at an appropriate position outside the vehicle 100 in order to sense an object located in front of the vehicle 100, an object located to the rear of the vehicle 100, or an object located to the side of the vehicle 100.

The processor 370 may control the overall operation of each unit of the object detection device 300. The processor 370 may detect and track an object based on acquired images. The processor 370 may calculate the distance to the object and the speed relative to the object, determine a type, location, size, shape, color, moving path of the object, and determine a sensed text.

The processor 370 may detect and track an object based on a reflection electromagnetic wave which is formed as a result of reflection a transmission electromagnetic wave by the object. Based on the electromagnetic wave, the processor 370 may, for example, calculate the distance to the object and the speed relative to the object.

The processor 370 may detect and track an object based on a reflection laser light which is formed as a result of reflection of transmission laser by the object. Based on the laser light, the processor 370 may calculate the distance to the object and the speed relative to the object.

The processor 370 may detect and track an object based on a reflection ultrasonic wave which is formed as a result of reflection of a transmission ultrasonic wave by the object. Based on the ultrasonic wave, the processor 370 may calculate the distance to the object and the speed relative to the object.

The processor 370 may detect and track an object based on reflection infrared light which is formed as a result of reflection of transmission infrared light by the object. Based on the infrared light, the processor 370 may calculate the distance to the object and the speed relative to the object.

The processor 370 may generate object information based on at least one of the following: an information acquired using the camera 310, a reflected electronic wave received using the radar 320, a reflected laser light received using the lidar 330, and a reflected ultrasonic wave received using the ultrasonic sensor 340, and a reflected infrared light received using the infrared sensor 350. The processor 370 may provide the object information to the controller 170.

The object information may be information about a type, location, size, shape, color, a moving path, and speed of an object existing around the vehicle 100 and information about a sensed text. The object information may indicate: whether a traffic line exists in the vicinity of the vehicle 100; whether any nearby vehicle is travelling while the vehicle 100 is stopped; whether there is a space in the vicinity of the vehicle 100 to stop; whether a vehicle and an object could collide; where a pedestrian or a bicycle is located with reference to the vehicle 100; a type of a roadway in which the vehicle 100 is travelling, a status of a traffic light in the vicinity of the vehicle 100, and movement of the vehicle 100.

The object detection device 300 may include a plurality of processors 370 or may not include the processor 370. For example, each of the camera 310, the radar 320, the lidar 330, the ultrasonic sensor 340, and the infrared sensor 350 may include its own processor.

The object detection device 300 may operate under control of the controller 170 or a processor inside the vehicle 100.

The communication device 400 is configured to perform communication with an external device. Here, the external device may be a nearby vehicle, a user's terminal, or a server.

To perform communication, the communication device 400 may include at least one selected from among a transmission antenna, a reception antenna, a Radio Frequency (RF) circuit capable of implementing various communication protocols, and an RF device.

The communication device 400 may include a short-range communication unit 410, a location information unit 420, a V2X communication unit 430, an optical communication unit 440, a broadcast transmission and reception unit 450, and a processor 470.

The short-range communication unit 410 is configured to perform short-range communication. The short-range communication unit 410 may support short-range communication using at least one selected from among Bluetooth™, Radio Frequency IDdentification (RFID), Infrared Data Association (IrDA), Ultra-WideBand (UWB), ZigBee, Near Field Communication (NFC), Wireless-Fidelity (Wi-Fi), Wi-Fi Direct, and Wireless USB (Wireless Universal Serial Bus).

The short-range communication unit 410 may form wireless area networks to perform short-range communication between the vehicle 100 and at least one external device.

The location information unit 420 is configured to acquire location information of the vehicle 100. For example, the location information unit 420 may include at least one of a Global Positioning System (GPS) module, a Differential Global Positioning System (DGPS) module, and a Carrier phase Differential GPS (CDGPS) module.

The V2X communication unit 430 is configured to perform wireless communication between a vehicle and a server (that is, vehicle to infra (V2I) communication), wireless communication between a vehicle and a nearby vehicle (that is, vehicle to vehicle (V2V) communication), or wireless communication between a vehicle and a pedestrian (that is, vehicle to pedestrian (V2P) communication).

The optical communication unit 440 is configured to perform communication with an external device through the medium of light. The optical communication unit 440 may include a light emitting unit, which converts an electrical signal into an optical signal and transmits the optical signal to the outside, and a light receiving unit which converts a received optical signal into an electrical signal. The light emitting unit may be integrally formed with a lamp provided included in the vehicle 100.

The broadcast transmission and reception unit 450 is configured to receive a broadcast signal from an external broadcasting management server or transmit a broadcast signal to the broadcasting management server through a broadcasting channel. The broadcasting channel may include a satellite channel, and a terrestrial channel. The broadcast signal may include a TV broadcast signal, a radio broadcast signal, and a data broadcast signal.

The processor 470 may control the overall operation of each unit of the communication device 400. The processor 470 may generate vehicle driving information based on information received through at least one of a short range communication unit 410, a location information unit 420, a V2X communication unit 430, an optical communication unit 440, and a broadcast transmitting and receiving unit 450. The processor 470 may generate vehicle driving information based on information on a location, model, driving route, speed, and various sensing values of another vehicle OB11 received from the other vehicle OB11. When information on various sensing values of the other vehicle OB11 is received, even if there is no separate sensor in the vehicle 100, the processor 470 may obtain information on a peripheral object of the vehicle 100.

In a case where the communication device 400 does not include the processor 470, the communication device 400 may operate under control of the controller 170 or a processor of a device inside of the vehicle 100.

The communication device 400 may implement a vehicle display device, together with the user interface device 200. In this case, the vehicle display device may be referred to as a telematics device or an Audio Video Navigation (AVN) device.

The controller 170 may transmit at least one of driver status information, vehicle status information, vehicle driving information, error information representing an error of the vehicle 100, and object information based on a signal received from the communication device 400, a user input received through the user interface device 200, and a remote control request signal to an external device. The remote control server may determine whether the remote control is required in the vehicle 100 based on information sent by the vehicle 100.

The controller 170 may control the vehicle 100 according to a control signal received from a remote control server through the communication device 400.

The controller 170 may further include an AI processor 800. The AI processor 800 may be applied to an autonomous driving mode based on learning results thereof or learning results of the server 2000.

The maneuvering device 500 is configured to receive a user command for driving the vehicle 100. In the manual driving mode, the vehicle 100 may operate based on a signal provided by the maneuvering device 500.

The maneuvering device 500 may include a steering input device 510, an acceleration input device 530, and a brake input device 570.

The steering input device 510 may receive a user command for steering of the vehicle 100. The user command for steering may be a command corresponding to a specific steering angle. The steering input device 510 may take the form of a wheel to enable a steering input through the rotation thereof. In some implementations, the steering input device may be provided as a touchscreen, a touch pad, or a button.

The acceleration input device 530 may receive a user command for acceleration of the vehicle 100. The brake input device 570 may receive a user command for deceleration of the vehicle 100. Each of the acceleration input device 530 and the brake input device 570 may take the form of a pedal. In some implementations, the acceleration input device or the break input device may be configured as a touch screen, a touch pad, or a button.

The maneuvering device 500 may operate under control of the controller 170.

The vehicle drive device 600 is configured to electrically control the operation of various devices of the vehicle 100. The vehicle drive device 600 may include a power train drive unit 610, a chassis drive unit 620, a door/window drive unit 630, a safety apparatus drive unit 640, a lamp drive unit 650, and an air conditioner drive unit 660.

The power train drive unit 610 may control the operation of a power train. The power train drive unit 610 may include a power source drive unit 611 and a transmission drive unit 612.

The power source drive unit 611 may control a power source of the vehicle 100. In the case in which a fossil fuel-based engine is the power source, the power source drive unit 611 may perform electronic control of the engine. As such the power source drive unit 611 may control, for example, the output torque of the engine. The power source drive unit 611 may adjust the output toque of the engine under control of the controller 170.

The transmission drive unit 612 may control a transmission. The transmission drive unit 612 may adjust the state of the transmission. The transmission drive unit 612 may adjust a state of the transmission to a drive (D), reverse (R), neutral (N), or park (P) state. In some implementations, in a case where an engine is the power source, the transmission drive unit 612 may adjust a gear-engaged state to the drive position D.

The chassis drive unit 620 may control the operation of a chassis. The chassis drive unit 620 may include a steering drive unit 621, a brake drive unit 622, and a suspension drive unit 623.

The steering drive unit 621 may perform electronic control of a steering apparatus provided inside the vehicle 100. The steering drive unit 621 may change the direction of travel of the vehicle 100.

The brake drive unit 622 may perform electronic control of a brake apparatus provided inside the vehicle 100. For example, the brake drive unit 622 may reduce the speed of the vehicle 100 by controlling the operation of a brake located at a wheel. In some implementations, the brake drive unit 622 may control a plurality of brakes individually. The brake drive unit 622 may apply a different degree-braking force to each wheel.

The suspension drive unit 623 may perform electronic control of a suspension apparatus inside the vehicle 100. For example, when the road surface is uneven, the suspension drive unit 623 may control the suspension apparatus so as to reduce the vibration of the vehicle 100. In some implementations, the suspension drive unit 623 may control a plurality of suspensions individually.

The door/window drive unit 630 may perform electronic control of a door device or a window device inside the vehicle 100. The door/window drive unit 630 may include a door drive unit 631 and a window drive unit 632. The door drive unit 631 may control the door device. The door drive unit 631 may control opening or closing of a plurality of doors included in the vehicle 100. The door drive unit 631 may control opening or closing of a trunk or a tail gate. The door drive unit 631 may control opening or closing of a sunroof.

The window drive unit 632 may perform electronic control of the window device. The window drive unit 632 may control opening or closing of a plurality of windows included in the vehicle 100.

The safety apparatus drive unit 640 may perform electronic control of various safety apparatuses provided inside the vehicle 100. The safety apparatus drive unit 640 may include an airbag drive unit 641, a safety belt drive unit 642, and a pedestrian protection equipment drive unit 643.

The airbag drive unit 641 may perform electronic control of an airbag apparatus inside the vehicle 100. For example, upon detection of a dangerous situation, the airbag drive unit 641 may control an airbag to be deployed.

The safety belt drive unit 642 may perform electronic control of a seatbelt apparatus inside the vehicle 100. For example, upon detection of a dangerous situation, the safety belt drive unit 642 may control passengers to be fixed onto seats 110FL, 110FR, 110RL, and 110RR with safety belts.

The pedestrian protection equipment drive unit 643 may perform electronic control of a hood lift and a pedestrian airbag. For example, upon detection of a collision with a pedestrian, the pedestrian protection equipment drive unit 643 may control a hood lift and a pedestrian airbag to be deployed.

The lamp drive unit 650 may perform electronic control of various lamp apparatuses provided inside the vehicle 100.

The air conditioner drive unit 660 may perform electronic control of an air conditioner inside the vehicle 100.

The operation system 700 is a system for controlling the overall operation of the vehicle 100. The operation system 700 may operate in an autonomous mode. In a case where the operation system 700 is implemented as software, the operation system 700 may be a subordinate concept of the controller 170.

The operation system 700 may be a concept including at least one selected from among the user interface device 200, the object detection device 300, the communication device 400, the vehicle drive device 600, and the controller 170.

The driving system 710 may provide a control signal to the vehicle drive device 600 in response to reception of navigation information from the navigation system 770. The navigation information may include route information necessary for autonomous travel such as destination and waypoint information. The navigation information may include a map data, traffic information, and the like.

The driving system 710 may provide a control signal to the vehicle drive device 600 in response to reception of object information from the object detection device 300. The driving system 710 may provide a control signal to the vehicle drive device 600 in response to reception of a signal from an external device through the communication device 400.

The parking-out system 740 may park the vehicle 100 out of a parking space. The parking-out system 740 may provide a control signal to the vehicle drive device 600 based on location information of the vehicle 100 and navigation information provided by the navigation system 770. The parking-out system 740 may provide a control signal to the vehicle drive device 600 based on object information provided by the object detection device 300. The parking-out system 740 may provide a control signal to the vehicle drive device 600 based on a signal provided by an external device received through the communication device 400.

The parking system 750 may park the vehicle 100 in a parking space. The vehicle parking system 750 may provide a control signal to the vehicle drive device 600 based on the navigation information provided by the navigation system 770. The parking system 750 may provide a control signal to the vehicle drive device 600 based on object information provided by the object detection device 300. The parking system 750 may provide a control signal to the vehicle drive device 600 based on a signal provided by an external device received through the communication device 400.

The navigation system 770 may provide navigation information. The navigation information may include at least one of the following: map information, information on a set destination, information on a route to the set destination, information on various objects along the route, lane information, and information on the current location of a vehicle. The navigation system 770 may include a memory and a processor. The memory may store navigation information. The processor may control the operation of the navigation system 770. The navigation system 770 may update pre-stored information by receiving information from an external device through the communication device 400. The navigation system 770 may be classified as an element of the user interface device 200.

The sensing unit 120 may sense the state of the vehicle. The sensing unit 120 may include an attitude sensor, a collision sensor, a wheel sensor, a speed sensor, a gradient sensor, a weight sensor, a heading sensor, a yaw sensor, a gyro sensor, a position module, a vehicle forward/reverse movement sensor, a battery sensor, a fuel sensor, a tire sensor, a steering sensor based on the rotation of the steering wheel, an in-vehicle temperature sensor, an in-vehicle humidity sensor, an ultrasonic sensor, an illumination sensor, an accelerator pedal position sensor, and a brake pedal position sensor. For example, the attitude sensor may include yaw sensor, roll sensor, pitch sensor, etc.

The sensing unit 120 may acquire sensing signals with regard to, for example, vehicle attitude information, vehicle collision information, vehicle driving direction information, vehicle location information (GPS information), vehicle angle information, vehicle speed information, vehicle acceleration information, vehicle tilt information, vehicle forward/reverse movement information, battery information, fuel information, tire information, vehicle lamp information, in-vehicle temperature information, in-vehicle humidity information, steering-wheel rotation angle information, out-of-vehicle illumination information, information about the pressure applied to an accelerator pedal, and information about the pressure applied to a brake pedal.

The sensing unit 120 may further include, for example, an accelerator pedal sensor, a pressure sensor, an engine speed sensor, an Air Flow-rate Sensor (AFS), an Air Temperature Sensor (ATS), a Water Temperature Sensor (WTS), a Throttle Position Sensor (TPS), a Top Dead Center (TDC) sensor, and a Crank Angle Sensor (CAS).

The interface 130 may serve as a passage for various kinds of external devices that are connected to the vehicle 100. For example, the interface 130 may have a port that is connectable to a mobile terminal and may be connected to the mobile terminal via the port. In this case, the interface 130 may exchange data with the mobile terminal.

The interface 130 may serve as a passage for the supply of electrical energy to a user's terminal connected thereto. When the user's terminal is electrically connected to the interface 130, the interface 130 may provide electrical energy, supplied from the power supply unit 190, to the user's terminal under control of the controller 170.

The memory 140 is electrically connected to the controller 170. The memory 140 may store basic data for each unit, control data for the operational control of each unit, and input/output data. The memory 140 may store various data for the overall operation of the vehicle 100, such as programs for the processing or control of the controller 170. The memory 140 may be any of various hardware storage devices, such as a ROM, a RAM, an EPROM, a flash drive, and a hard drive.

The memory 140 may be integrally formed with the controller 170, or may be provided as an element of the controller 170.

The controller 170 may control overall operation of each unit in the vehicle 100. The controller 170 may include an ECU. The controller 170 may control the vehicle 100 based on information obtained through at least one of the object detection device 300 and the communication device 400. Accordingly, the vehicle 100 may perform autonomous driving under the control of the controller 170.

At least one processor and the controller 170 included in the vehicle 100 may be implemented using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electric units for the implementation of other functions.

The power supply unit 190 may receive power from a battery in the vehicle. The power supply unit 190 may supply power necessary for an operation of each component to components under the control of the controller 170.

The vehicle 100 may include an In-Vehicle Infotainment (IVI) system. The IVI system may operate in connection with the user interface device 200, the communication device 400, the controller 170, the navigation system 770, and the operation system 700. The IVI system reproduces multimedia contents in response to a user input and executes User Interfaces (UI) or User Experience (UX) program for various application programs.

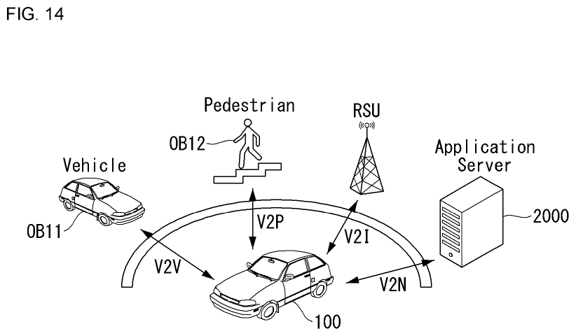

FIG. 14 is a diagram illustrating V2X communication.

Referring to FIG. 14, V2X communication includes communication between vehicle and all entities such as Vehicle-to-Vehicle (V2V) indicating communication between vehicles, Vehicle to Infrastructure (V2I) indicating communication between a vehicle and an eNB or a Road Side Unit (RSU), vehicle-to-pedestrian (V2P) indicating communication between a vehicle and a user equipment (UE) carried by an individual (pedestrian, bicyclist, vehicle driver, or passenger), and vehicle-to-network (V2N). V2X communication may represent the same meaning as that of a V2X side link or NR V2X or may represent a more broad meaning including a V2X side link or NR V2X.

V2X communication may be applied to various services such as a forward collision warning, an automatic parking system, cooperative adaptive cruise control (CACC), a control loss warning, a traffic line warning, a traffic vulnerable person safety warning, an emergency vehicle warning, a speed warning upon driving a curved road, and traffic flow control.

V2X communication may be provided through a PC5 interface and/or a Uu interface. In this case, in a wireless communication system supporting V2X communication, a specific network entity for supporting communication between the vehicle and all entities may exist. For example, the network entity may be a BS (eNB), a road side unit (RSU), a UE, or an application server (e.g., traffic security server).

Further, a user terminal (UE) that performs V2X communication may mean a general handheld UE, a Vehicle UE (V-UE), a pedestrian UE, an eNB type RSU, a UE type RSU, or a robot having a communication module.

V2X communication may be directly performed between UEs or may be performed through the network object(s). According to an execution method of such V2X communication, a V2X operation mode may be classified.

In V2X communication, it is required to support privacy and pseudonymity of the UE when using a V2X application so that an operator or a third party may not track an UE identity in a region in which V2X is supported.

A term frequently used in V2X communication is defined as follows:
Road Side Unit (RSU): The RSU is a V2X serviceable device capable of transmitting/receiving to and from a moving vehicle using a V2I service. Further, the RSU is a fixed infrastructure entity that supports a V2X application and may exchange a message with another entity supporting a V2X application. The RSU is a term frequently used in an existing ITS specification, and the reason of introducing the term in a 3GPP specification is to enable to more easily read a document in an ITS industry. The RSU is a logical entity that couples V2X application logic to a function of the BS (referred to as a BS-type RSU) or the UE (referred to as a UE-type RSU).

V2I service: one type of the V2X service, one side thereof is a vehicle and the other side thereof is an entity belonging to an infrastructure.

V2P service: one type of the V2X service, one side thereof is a vehicle, and the other side thereof is a device (e.g., a mobile UE carried by a pedestrian, a bicyclist, a driver, or a passenger) carried by an individual.

V2X service: 3GPP communication service type in which a transmitting or receiving device is related to a vehicle.

V2X enabled UE: UE that supports a V2X service.

V2V service: a type of a V2X service, and both sides of communication are vehicles.

V2V communication range: direct communication range between two vehicles participating to the V2V service.

An V2X application referred to as Vehicle-to-Everything (V2X) has four types of (1) vehicle to vehicle (V2V), (2) vehicle to infrastructure (V2I), (3) vehicle to network (V2N), and (4) vehicle to pedestrian (V2P).

The V2X application may use “co-operative awareness” that provides a more intelligent service for a final user. This means that entities such as vehicles 100 and OB11, an RSU, an application server 2000, and a pedestrian OB12 may correct knowledge (e.g., information received from adjacent other vehicle or sensor equipment) on a corresponding region environment so that the entities handle and share the corresponding knowledge in order to provide more intelligent information such as cooperative collision warning or autonomous driving.

When a vehicle drives a private road, a user may register in a service provided by a section service provider to receive a driving priority. In this case, when the vehicle drives a corresponding section of the private road, the vehicle 100 or the server 2000 may communicate with peripheral vehicles to receive a concession of a service non-subscriber vehicle and drive a corresponding section in a high speed. The vehicle 100 or the server 2000 may control deceleration and a driving direction of a non-subscriber vehicle.

According to the present invention, a section and a time zone of a private road are allocated to section service providers that are won by an auction of the section and the time zone of the private road (private autonomous road). The section service provider may participate in an auction for a section and a time zone of a private road.

The sectional service provider may provide a service of a high traffic quality to a user (vehicle user) through traffic quality and traffic volume management of a section having a possessory right in a private road.

An evaluation score of a bidding participating company who participates in an auction of a section and time zone of a private road may be calculated according to traffic quality management, user satisfaction, and traffic congestion.

The bidding participating company may receive allocation of a time zone and a section having a possessory right in a private road according to an evaluation score and a suggested use amount. Even in the same section, a section service provider, which is a successful bidder may be different according to a time zone.

The section service provider, having received allocation of a section and time of a private road may provide a service that manages a traffic quality at a section of a private road having a possessory right and that increases a driving speed to the service subscriber. The section service provider may provide a driving priority to a service subscriber vehicle through the vehicular control of a non-subscriber vehicle that is not registered in the service at the corresponding section. For example, in the case of a lane change, toll gate entry, and toll gate exit, the section service provider may control a speed and an advancing direction of a non-subscriber vehicle to increase a driving speed of the subscriber vehicle.

When a user inputs a destination, the server 2000 guides a traffic volume, provider information, and a cost of each section of a private road on a driving route advancing to a destination. The provider information notifies a section service provider. The cost is a road use cost including a service charge to be paid to the section service provider. The present invention can store history information of a company using each section of a private road in a driving route to a destination of each user in a database (DB) to use the history information of a company using each section in order to improve a traffic quality.

The present invention may promote investment for road construction of an autonomous vehicle manufacturer through an auction method of each section of a private road. The present invention may shorten a driving time of a vehicle with traffic volume distribution using an idle road and improve a service satisfaction level through traffic quality management of a section service provider. The present invention may provide various driving routes to a destination when a user inputs the destination, a traffic volume of each section of each driving route, a section service provider, cost information, and the like.

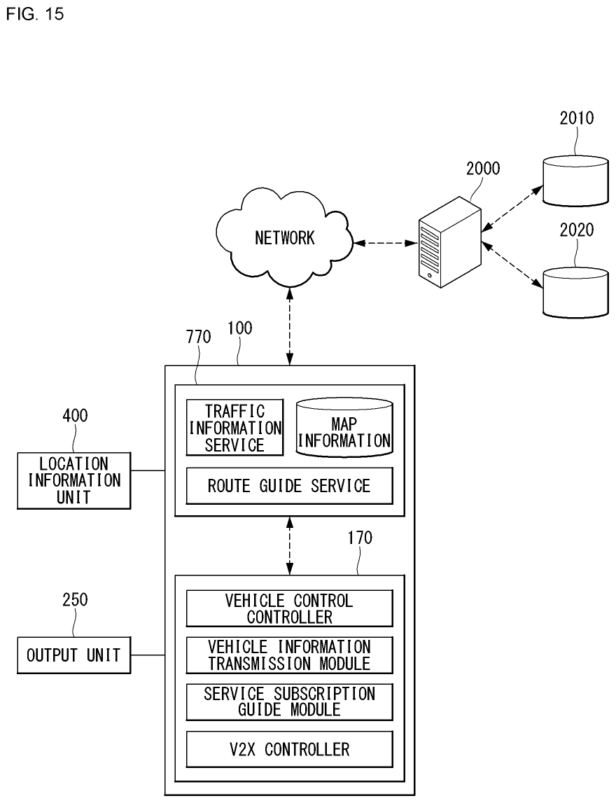

FIG. 15 is a diagram illustrating a driving control system according to an embodiment of the present invention.

Referring to FIG. 15, the driving control system includes a vehicle 100 and a server 2000 connected through a network. Further, the driving control system may further include a user terminal 1000 connected to the network.

The navigation system 770 of the vehicle 100 provides a traffic information service, map data, and a route guide service. When the user enters a destination, the navigation system 770 may provide a current location (starting point) of the vehicle and a driving route to a destination to the server 2000. The navigation system 770 may match information received from the server 2000 on a map to which a driving route is mapped to provide the information to the user through the output unit 250. GPS coordinates received from the location information unit 4000 indicate a current position of the vehicle.

The navigation system 770 may match traffic volume information of each section, company information of a section service provider, and road use cost information received from the server 2000 on a driving route to display the information in the display. When a vehicle is registered in the service provided by the section service provider by the user, the controller 170 may control at least one of a speed and an advancing direction of other vehicle through communication (V2V) between vehicles at a section occupied by the section service provider to exert a driving priority of the vehicle 100 at the corresponding section.

The controller 170 includes a vehicle control controller, a vehicle information transmission module, a service subscription guide module, and a V2X controller. The vehicle control controller controls a driving operation device 500, a vehicle drive device 600, and an operation system 700 in a manual mode, an autonomous mode, or a remote control mode.

The vehicle information transmission module transmits current position (starting point), destination, and driving route information of the vehicle to the server 2000. The vehicle information transmission module transmits user or vehicle information for registration of each section service to the server 2000. The vehicle information transmission module may transmit vehicle driving information and vehicle status information to the server 2000. The vehicle information transmission module may transmit a driving control request signal for controlling at least one of a speed and an advancing moving direction of other vehicle to the other vehicle through the V2X controller.

The service subscription guide module may display a screen for guiding subscription of a section service in a display of the output unit 250 and display whether subscription approval of a section service received from the server 2000 in the display.

The user terminal may include a service subscription guide module. In this case, the user may register in a section service provided by the section service provider on a driving route using the user terminal.

The server 2000 may include first and second databases 2010 and 2020. The first database 2010 stores section service provider information, history management information of the section service provider and the like under the control of the server 2000. The second database 2020 stores a user and vehicle information registered in a service of the section service provider under the control of the server 2000.

The server 2000 may store a section service provider and section cost information at the first database 2010, and search for the first database 2010 to read a cost and a section service provider having a possessory right of a private road section on a road route selected by the user and to transmit the cost and the section service provider to the vehicle 100 or user terminal. The server 2000 may store section service registration information in the second database 2020 and search for the second database 2020 to transmit service registration information to the vehicle 100 or the user terminal.

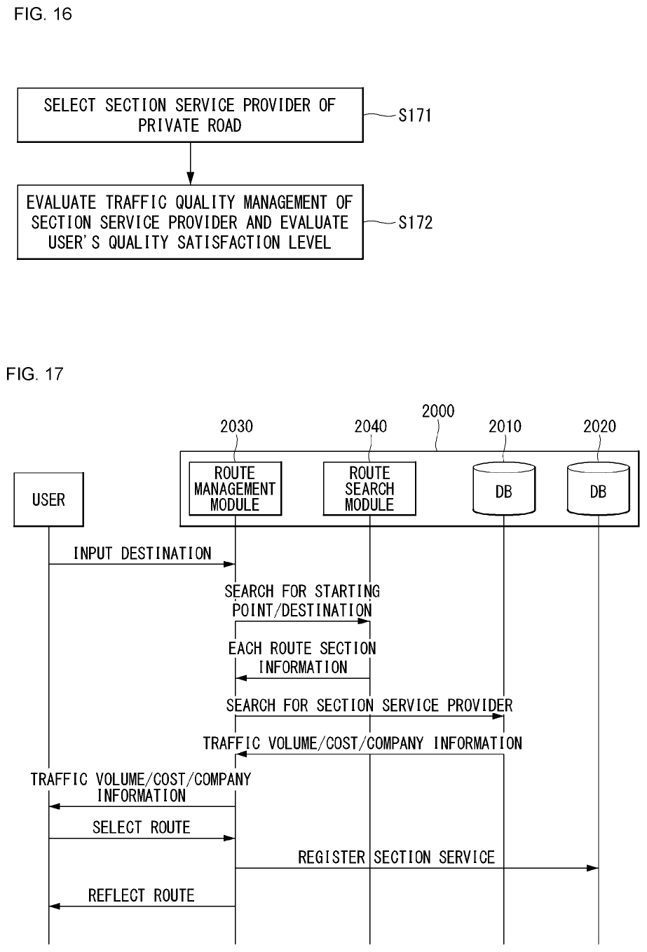

FIG. 16 is a flowchart illustrating selection of a section service provider of a private road, a section traffic quality, and user satisfaction evaluation.

Referring to FIG. 16, a section service provider of a private road is selected (S171).

The section service provider may be selected through an auction for a time, a section, and a traffic volume. Traffic quality management evaluation of the section service provider selected by the auction and evaluation of the user's quality satisfaction level may be reflected to a company's evaluation score when participating in bidding at the next auction (S172). Therefore, the section service provider should manage a traffic quality and the user's quality satisfaction level of a segment in which it occupies.

A traffic volume (%) may be calculated by dividing the total number of simultaneous drivable vehicles by the number of allowable vehicles. Hereinafter, an appropriate traffic volume means a traffic volume in which a driving speed of a vehicle is guaranteed to an appropriate level at the corresponding road section in consideration of characteristics of a road section.

As an example of an auction method, an auction may be held for a section service provider of a time volume 70% (700 vehicles/1000 vehicles) in a specific private road at a time zone between 10:00 am and 12:00 am.

A congestion type of each section of a private road may be classified according to an average traffic volume of each time zone. Section congestion may be used for an evaluation score. A section service provider may be selected according to an evaluation score and a section use cost provided by a bidder.

The traffic volume may be divided into a congestion section, an intermittent congestion section, and a margin section, as in the following example.

The congestion section may be set to a private road section having an average traffic volume of 70% or more of an appropriate traffic volume in the corresponding section. A reflection score, for example, one point of the congestion section may be reflected to an evaluation score of a bidder (company).

The intermittent congestion section may be set to a road section having an average traffic volume of 40 to 70% to an appropriate traffic volume of the corresponding section. A reflection score, for example, five points of the intermittent congestion section may be reflected to an evaluation score of a bidder (company).

The margin section may be set to a road section having an average traffic volume of less than 40% to an appropriate traffic volume of the corresponding section. A reflection score, for example, ten points of the margin section may be reflected to an evaluation score of a bidder (company).

Auction participating companies participate in an auction with a company evaluation score. The company evaluation score may be applied as follows, but it not limited thereto.

Company evaluation score=(a) Traffic quality management score+(b) passenger's quality satisfaction level+(c) average occupied road congestion level up to now

(a) The Road Traffic Authority checks a traffic quality execution level of a section service provider, and a traffic quality score is a value of check progress calculated with a score.

(b) The passenger's quality satisfaction level is a satisfaction level collected from a user using a service provided by the section service provider.

(c) An average occupied road congestion level up to now may be calculated as a total congestion level average of an occupied road up to now.

A business structure of a private road in which an autonomous vehicle drives may be a structure in which a section service provider and an autonomous vehicle provider participate in a 1:N ratio. The section service provider and the autonomous vehicle provider may be the same.

A bid participant (section service provider) manages a total traffic volume of a corresponding section of a private road. The bid participant may be a road providing provider, an autonomous vehicle manufacturer, a communication company, a service provider and the like. The autonomous vehicle manufacturer is an original equipment manufacturer (OEM). The service provider may be a company that provides a service using an autonomous vehicle, for example, a company that dispatches a sharing vehicle or an autonomous vehicle to a user through a user terminal.

The autonomous vehicle provider is a company that receives allocation of a traffic volume of a road. The autonomous vehicle provider may be a road providing provider, an autonomous vehicle manufacturer, a communication company, a service provider and the like.

A driving route package and a company mileage service configured with only a road having the same road providing provider and section service provider may be sold to a user. For example, A company route package flat rate or A company mileage service may be provided.

When the road providing provider and the section service provider are an autonomous vehicle manufacturer or a service provider, if a sharing vehicle is called, a vehicle of the autonomous vehicle manufacturer or a vehicle of the service provider may be first dispatched. For example, when the user sets a route, a vehicle of a main use company may be first dispatched on an entire driving route.

When the road providing provider and the section service provider are the same communication provider, a high performance communication band service using a 5G network may be provided at the corresponding section. For example, when the vehicle enters the corresponding road section, a 5G communication service may be provided.

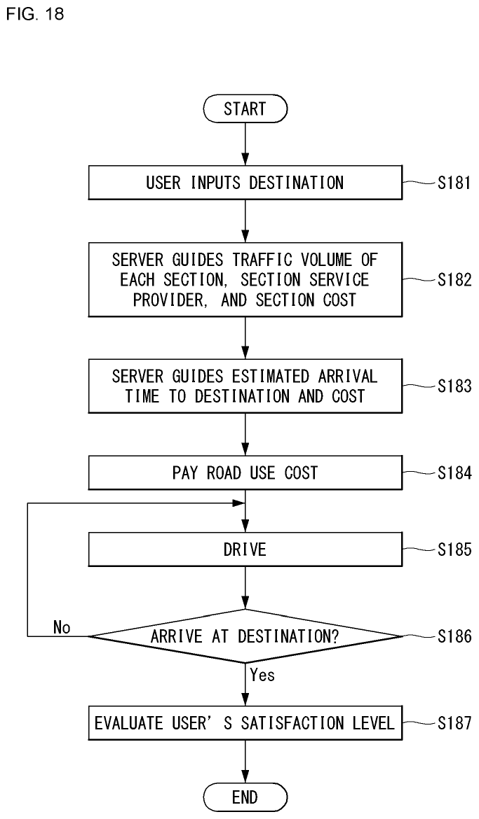

FIG. 17 is a message flow diagram illustrating transmitting and receiving messages between a user and a server in a driving control system. FIG. 18 is a flowchart illustrating a method of controlling driving according to an embodiment of the present invention. In FIGS. 17 and 18, the user may be interpreted as the user terminal or the vehicle 100.

Referring to FIGS. 17 and 18, the server 2000 receives starting point and destination information from the vehicle 100 to generate traffic volume information of each divided section at a private road section of a driving route to a destination, information of a section service provider, and cost information. The server 2000 may further include a route management module 2030 and a route search module 204.

The user may input a destination through the navigation system 770 of the user terminal or the vehicle 100 (S181). The route management module 2030 may transmit starting point and destination information received from the user to the route search module 204 to request driving route search. The route search module 204 transmits section information divided into a private road section on at least one driving route connecting the starting point and the destination to the route management module 2030.

When information of each section of a driving route is received from the route search module 204, the route management module 2030 searches for provider information of the first database 2010 in response to the received section information. The route management module 2030 may transmit a service provider of each section of a private road, a section use cost set by the provider, and a current traffic volume of the corresponding section found in the first database 2010 to the user. Further, the route management module 2030 may transmit an estimated arrival time to a destination in a driving route selected by the user to the user (S182 and S183). The server 2000 may calculate a traffic volume based on a camera image photographing in real time a traffic situation in a road or a location of vehicles collected through V2X. The server 2000 may calculate an estimated arrival time in consideration of a traffic volume, a congestion level, and the like.

The user may select a driving route through an IVI system of the vehicle or the user terminal based on traffic volume, cost, and provider information of each section. In order for the user to arrive at a destination more quickly, even if the user pays an additional cost, the user may select a driving route including a private road section with a low traffic volume.

The route management module 2030 stores user information and vehicle information at a section service provider database of the second database 2020. As a result, the user is registered as a subscriber to a service provided by a section service provider of a private road included on a driving route selected by the user. When subscriber registration to a service of a section service provider has been completed, the route management module 2030 reflects service registration to the user's driving route. The navigation system of the user terminal or the vehicle 100 may apply whether a section service is registered on the driving route to display the registered section service on a map.

The user may select a driving route including a private road section to pay the section service provider (S184). The vehicle 100 may drive along the driving route including the private road section (S185).

The number of a private road section in which a section service provider has a possessory right on a driving route to a destination may be at least one. The user may use two or more sections occupied by the section service provider on the driving route.

For example, in a driving route from a starting point to a destination, a first road including a private road in which a section service is provided by a company A and a second road including a private road in which a section service is provided by a company B may be guided. The user may select a driving route passing through a first road including a section occupied by the company A to receive a driving priority service provided by the company A.

The user may select a different service provider at each section on the driving route. A section service use cost and a section service provider may be different according to a vehicle driving time.

After setting of a driving route to a destination is completed, the server 2000 may guide a section service provider, a final cost, a traffic volume, and a shortened time compared to when using a free road to an occupant for a driving route finally selected in step S183. For example, the server 2000 may provide a guide such as “A driving priority service may be provided at a section 1 of a private road in the selected driving route. In a first road, a service is provided by a company A, a total cost using the service is 1200 won, and a vehicle will be driven at a traffic volume of 40%. When using the first road, approximately 10 minutes is shortened compared to when using a free road” to the user in a display of the user terminal or the vehicle 100.

The server 2000 may store and manage driving route information (road information, company information) selected by the user for each user. After the user arrives at a destination, the server 2000 may collect user satisfaction to evaluate a quality satisfaction level of a service provided by a section service provider and reflect the quality satisfaction level when guiding a next route (S186, S187).

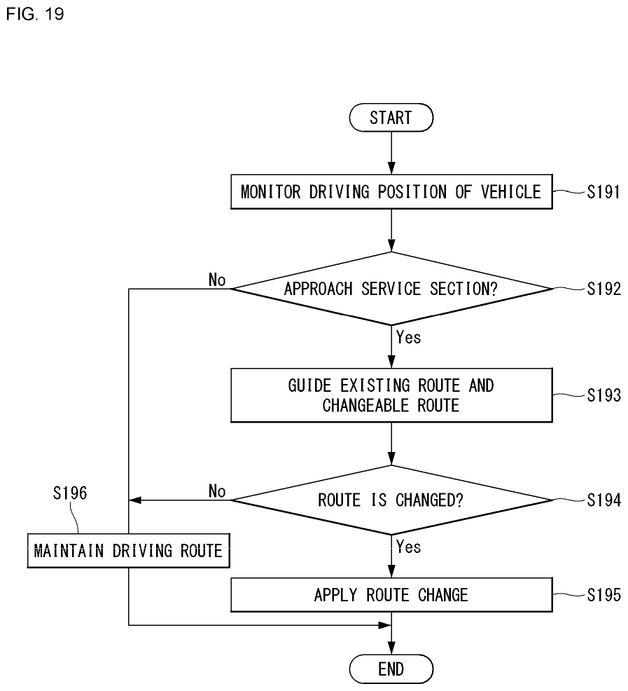

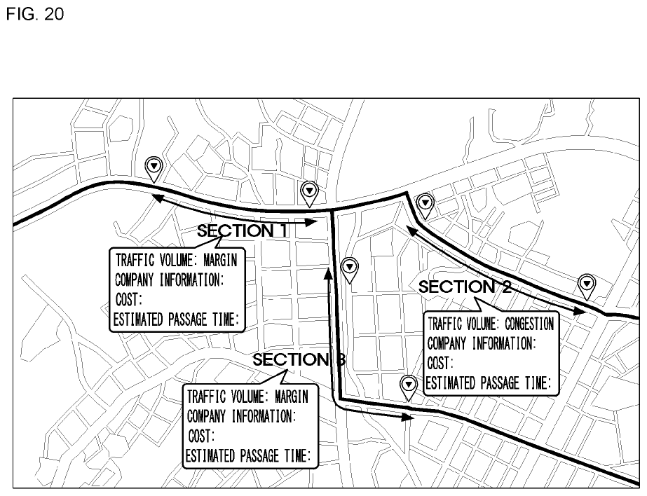

FIG. 19 is a flowchart illustrating a method of guiding an existing route and a changeable route while a vehicle drives. FIG. 20 is a diagram illustrating an example of showing a traffic volume, company information, a cost, and an estimated passing time of each section on a map.

Referring to FIGS. 19 and 20, the server 2000 may determine a current position and a vehicle state of the vehicle 100 based on vehicle driving information and vehicle status information received in real time from the vehicle 100. The server 2000 may monitor in real time whether the vehicle 100 enters a private road section based on GPS coordinates received from the vehicle 100 (S191).

While the vehicle 100 drives, when the vehicle 100 approaches a private road section occupied by the section service provider on a driving route, the server 2000 transmits existing route and changeable route information together with current real time traffic volume information received from the vehicle 100 to the user terminal or the vehicle 100 to guide the existing route and changeable route information to the user (S192, S193). Before the vehicle 100 enters a service section, i.e., a private road section occupied by a section service provider, the navigation system 770 may display the service section on a map illustrated in FIG. 20, as in the following example to match an existing route and a changeable route and to transmit information such as a section traffic volume and a cost to the user terminal or the vehicle 100.

The user terminal or the vehicle 100 may output a guide such as “A next service section is a section 2 (see FIG. 20) through a display and/or a speaker. A current traffic volume of the section 2, which is an existing route is 80% (congestion) and a cost of 1,000 won occurs. An estimated passing time of the section 2 is 40 minutes. The vehicle has been now subscribed to a driving priority service of a section 1.

As a changeable route, the route may be changed to a section 3 (see FIG. 20). A current traffic volume of the section 3 is 10% (margin), and a cost of 1,500 won may occur. An estimated passage time of the section 3 is 15 minutes and 25 minutes may be shortened compared to when using the section 2”.

The user terminal or the vehicle 100 may notify the user of penalty information received from the server 2000. For example, the user terminal or the vehicle 100 may output a guide such as “When a route is changed to a section 3, a service penalty fee, 200 won of the section 2 is added” to the user through a display and/or a speaker.

The user may select an existing route or a changeable route (S194, S195 and S196). The server 2000 reflects a route selected by the user to update a driving route use situation.

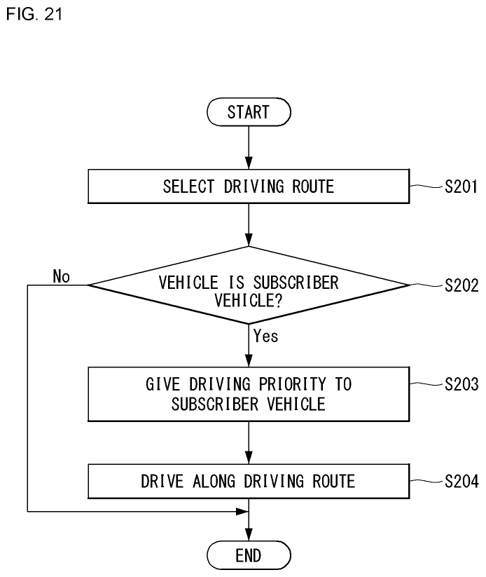

FIG. 21 is a flowchart illustrating an example of giving a driving priority to a subscriber vehicle in a private road.

Referring to FIG. 21, the user may select a driving route to a destination based on a traffic volume, a cost, and company information of a section service provider recommended by the server 2000 (S201).

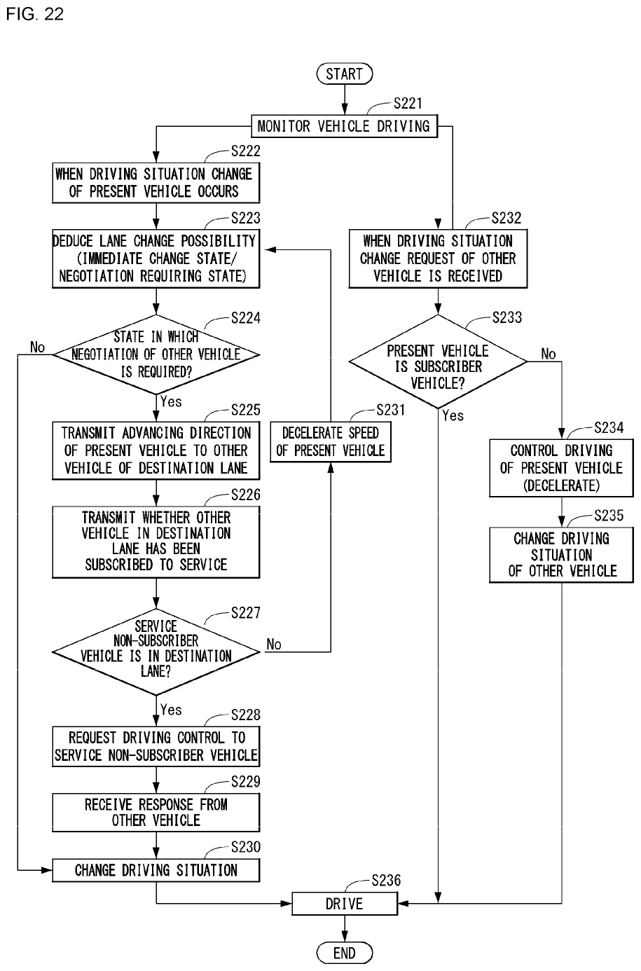

The user may subscribe to a service of a section service provider in a private road existing on the driving route. When the vehicle 100 entering a corresponding section of the private road is a subscriber vehicle, the section service provider gives a driving priority to the vehicle 100 (S202, S203). The subscriber vehicle may make a concession to a non-subscriber vehicle and drive at the corresponding section at a high speed (S204). When driving situations such as a lane change, toll gate entry, toll gate exit, a speed change, and a U-turn are changed, as in an example of FIG. 22, the subscriber vehicle may slow down a speed of a non-subscriber vehicle or control an advancing direction of a non-subscriber vehicle through communication (V2V) between vehicles.

FIG. 22 is a flowchart illustrating an example in which a driving priority of a subscriber vehicle is exerted through communication between vehicles. In FIG. 22, the present vehicle is a vehicle on which the user gets. The present vehicle is an autonomous vehicle for performing V2V communication with other vehicle.

Referring to FIG. 22, the server 2000 monitors in real time a driving situation of the vehicle 100 based on vehicle driving information and vehicle status information received in real time from the vehicle 100 (S221). For example, the server 2000 may analyze vehicle driving information and vehicle status information received from the vehicle 100 to monitor in real time a driving situation of the present vehicle. The server 2000 may determine whether a driving situation is changed, such as that the present vehicle and other vehicle change a lane, enter a toll gate, exist a toll gate, change a speed, or do a U-turn based on a driving situation of the vehicles.

The server 2000 checks a driving speed of vehicles around the present vehicle and a distance between vehicles in a current lane of the present vehicle when the present vehicle changes a lane and a destination lane in which the present vehicle is to enter. The server 2000 checks a traffic volume of each lane and a distance between vehicles when the vehicle enters/exits a toll gate. When a speed of the present vehicle is changed, the server 2000 checks a traffic volume around the present vehicle.

When a change in a driving situation of the present vehicle is attempted, the server 2000 deduces a lane change possibility of the present vehicle based on a distance between vehicles, a driving speed of the vehicle, and a traffic volume (S223). The server 2000 determines whether the present vehicle may directly enter a destination lane or whether a lane change to the destination lane requires negotiating with the other vehicle based on a distance between the present vehicle and other vehicle in a destination lane (S224).

When it is necessary to negotiate with the other vehicle in the destination lane (S224), the present vehicle transmits advancing direction information thereof and information on whether the present vehicle has been subscribed to a service to other vehicle in the destination lane (S225). The other vehicle in the destination lane transmits information on whether the other vehicle has been subscribed to a service to the present vehicle in response to the transmitted information (S226).

When the present vehicle is a subscriber vehicle and other vehicle in a destination lane close to the present vehicle is a service non-subscriber, the present vehicle transmits a driving control request signal to the other vehicle through communication (V2V) between vehicles (S227 and S228). Because the other vehicle is a non-subscriber vehicle, the other vehicle decelerates a driving speed in response to a driving control request signal of the present vehicle to secure a distance from the present vehicle (S229). The present vehicle may change a lane to a destination lane under a concession of the non-subscriber vehicle to exert a driving priority (S230 and S236). The driving control request signal may include a lane change attempt guide message of the subscriber vehicle notifying a user of the other vehicle and a vehicle control signal of directly controlling a speed and an advancing direction of the other vehicle.

An example of requesting a driving negotiation to the non-subscriber vehicle through communication (V2V) with a peripheral vehicle may be changed according to a driving situation change form.

When a subscriber vehicle changes a lane, a non-subscriber vehicle decelerates to secure a distance with the subscriber vehicle. The subscriber vehicle may cut and drive in front of the non-subscriber vehicle to exert a driving priority. When entering/exiting a toll gate, the non-subscriber vehicle may be controlled to decelerate and receive no entry control. The subscriber vehicle may cut in front of the non-entering vehicle to enter/exit into/from a tollgate and to exert a driving priority. When the subscriber vehicle accelerates, the non-subscriber vehicle driving in the corresponding lane in which the subscriber vehicle drives may temporarily move to another lane. The subscriber vehicle may continue driving at a high speed in the corresponding lane, and the non-subscriber vehicle may return to an original lane after the subscriber vehicle passes through.

The other vehicle may request a change in a driving situation. In this case, when the present vehicle is a subscriber vehicle, the present vehicle maintains a current driving state to continue driving (S232, S233, and S236). When the present vehicle is a non-subscriber vehicle, the present vehicle decelerates a driving speed in response to a driving control request signal received from the other vehicle to secure a distance between the vehicles (S234). Under a concession of the present vehicle, the other vehicle changes a driving situation (S235).

An autonomous vehicle and a driving speed control system and method using the same of the present invention may be described as follows.

An autonomous vehicle according to the present invention includes a navigation system for generating a driving route between a starting point and a destination and matching traffic volume information of each section of the driving route, information of a section service provider, and cost information received from an external server on the driving route to display the information in a display; and a controller for controlling a speed of other vehicle at a section occupied by the section service provider through communication between vehicles

The navigation system matches an estimated section passing time received from the external server to a map to display the estimated section passing time on the display.

When the controller is a controller of a subscriber vehicle registered in a section service provided by the section service provider, the controller lowers a driving speed of a non-subscriber vehicle of the section service at a section occupied by the section service provider through communication between vehicles.

The navigation system matches a predetermined existing route and a changeable route on a map before a vehicle enters at a section occupied by the section service provider to display the routes in the display. The navigation system matches a current traffic volume of the each section, the information of the section service provider, and the cost information on a map at each of the existing route and the changeable route to display the information in the display.

A driving control system of the present invention includes a server for receiving an input of starting point and destination information to generate traffic volume information of each divided section, information of a section service provider, and cost information at a road section of a driving route to the destination; and a navigation system for generating a driving route between the starting point and the destination and matching the traffic volume information of each section, the information of the section service provider, and the cost information received from the server on the driving route to display the information in a display, and a controller for controlling a speed of other vehicle at a section occupied by the section service provider through communication between vehicles.

The server includes first and second databases. The first database stores information of the section service provider and history management information of the section service provider under the control of the server. The second database stores vehicle information registered in a service of the section service provider under the control of the server.

The controller includes a vehicle control controller for controlling a maneuvering device, a vehicle drive device, and an operation system; a V2X controller for controlling a communication device for performing V2X communication to control communication between the vehicles; a vehicle information transmission module for transmitting the starting point, the destination, the driving route information, and vehicle information for registration of a section service provided by the section service provider to the server through the V2X controller; and a service subscription guide module for displaying a screen for guiding section service subscription in the display and displaying whether subscription approval of a section service received from the server in the display.

The vehicle information transmission module transmits a driving control request signal for controlling at least one of a speed and an advancing direction of other vehicle to the other vehicle through the V2X controller and a communication device.

The vehicle information transmission module transmits vehicle driving information and vehicle status information to the server. The vehicle driving information includes position information and posture information of the vehicle, and information received from other vehicle. The vehicle status information includes information on an operating state of a user interface device, an object detection device, a communication device for performing V2X communication, a maneuvering device, a vehicle drive device, and an operation system and information on whether each device is abnormal.

A method of controlling driving of a vehicle of the present invention includes searching for a section occupied by a section service provider in a driving route to a destination; determining whether the vehicle is a subscriber vehicle registered in a section service provided by the section service provider; and having, by the subscriber vehicle, a priority in a driving speed, compared to a non-subscriber vehicle when the subscriber vehicle drives a section occupied by the section service provider.

The driving control method further includes generating, by a server, traffic volume information of each section divided at a road section of the driving route, information of a section service provider, and cost information; matching, by a navigation system of a vehicle, the traffic volume information of each section, the information of the section service provider, and the cost information on the driving route to display the information in a display of the vehicle; and controlling a speed of other vehicle at a section occupied by the section service provider through communication between vehicles.

The driving control method further includes storing, by the server, information of the section service provider and history management information of the section service provider in a first database; and storing, by the server, vehicle information registered in a service of the section service provider in a second database.

The driving control method further includes transmitting vehicle information for registration of the starting point, the destination, the driving route information, and the each section service to the server through a communication device of a vehicle for performing V2X communication; and displaying a screen for guiding subscription of the each section service in a display of the vehicle and displaying whether subscription approval of the each section service received from the server in the display.

The driving control method further includes transmitting a driving control request signal for controlling at least one of a speed and an advancing direction of other vehicle to the other vehicle through the communication device.

The driving control method further includes transmitting vehicle driving information and vehicle status information to the server. The vehicle driving information includes position information and posture information of the vehicle and information received from other vehicle. The vehicle status information includes information on an operating state of a user interface device, an object detection device, the communication device, a maneuvering device, a vehicle drive device, and an operation system and information on whether each device is abnormal.

The driving control method further includes transmitting, by a subscriber vehicle registered in a section service provided by the section service provider, a driving control request signal to a non-subscriber vehicle of the section service at a section occupied by the section service provider through communication between the vehicles to lower a driving speed of the non-subscriber vehicle.

The present invention may be implemented as a computer readable code in a program recording medium. The computer readable medium includes all kinds of record devices that store data that may be read by a computer system. The computer may include a processor or a controller. The detailed description of the specification should not be construed as being limitative from all aspects, but should be construed as being illustrative. The scope of the present invention should be determined by reasonable analysis of the attached claims, and all changes within the equivalent range of the present invention are included in the scope of the present invention.

The features, structures, effects and the like described in the foregoing embodiments are included in at least an embodiment of the present invention and are not necessarily limited to an embodiment. Further, the features, structures, effects and the like illustrated in each embodiment can be combined and modified in other embodiments by those skilled in the art to which the embodiments belong. Therefore, it should be understood that contents related to such combinations and modifications are included in the scope of the present invention.

While the present invention has been described with reference to embodiments, the embodiments are only an illustration and do not limit the present invention, and it will be understood by those skilled in the art that various changes in form and details may be made therein without departing from the spirit and scope of the invention as defined by the appended claims. For example, each component specifically shown in the embodiments can be modified and implemented. It is to be understood that such variations and applications are to be construed as being included within the scope of the present invention as defined by the appended claims.

1. An autonomous vehicle, comprising:
a navigation system for generating a driving route between a starting point and a destination and matching traffic volume information of each section of the driving route, information of a section service provider, and cost information received from an external server on the driving route to display the information in a display; and
a controller for controlling a speed of other vehicle at a section occupied by the section service provider through communication between vehicles.

2. The autonomous vehicle of claim 1, wherein the navigation system matches an estimated section passing time received from the external server to a map to display the estimated section passing time on the display.

3. The autonomous vehicle of claim 1, wherein the controller lowers a driving speed of a non-subscriber vehicle of the section service at a section occupied by the section service provider through communication between vehicles, when the controller is a controller of a subscriber vehicle registered in a section service provided by the section service provider.

4. The autonomous vehicle of claim 1, wherein the navigation system is configured to:
match a predetermined existing route and a changeable route on a map before a vehicle enters at a section occupied by the section service provider to display the routes in the display; and
match a current traffic volume of the each section, the information of the section service provider, and the cost information on a map at each of the existing route and the changeable route to display the information in the display.

5. A driving control system, comprising:
a server for receiving an input of starting point and destination information to generate traffic volume information of each divided section, information of a section service provider, and cost information at a road section of a driving route to the destination; and
a navigation system for generating a driving route between the starting point and the destination and matching the traffic volume information of each section, the information of the section service provider, and the cost information received from the server on the driving route to display the information in a display, and a controller for controlling a speed of other vehicle at a section occupied by the section service provider through communication between vehicles.

6. The driving control system of claim 5, wherein the server comprises first and second databases,
wherein the first database stores information of the section service provider and history management information of the section service provider under the control of the server, and
wherein the second database stores vehicle information registered in a service of the section service provider under the control of the server.

7. The driving control system of claim 6, wherein the controller comprises:
a vehicle control controller for controlling a maneuvering device, a vehicle drive device, and an operation system;
a V2X controller for controlling a communication device for performing V2X communication to control communication between the vehicles;
a vehicle information transmission module for transmitting the starting point, the destination, the driving route information, and vehicle information for registration of a section service provided by the section service provider to the server through the V2X controller; and
a service subscription guide module for displaying a screen for guiding section service subscription in the display and displaying whether subscription approval of a section service received from the server in the display.

8. The driving control system of claim 7, wherein the vehicle information transmission module transmits a driving control request signal for controlling at least one of a speed and an advancing direction of other vehicle to the other vehicle through the V2X controller and a communication device.

9. The driving control system of claim 8, wherein the vehicle information transmission module transmits vehicle driving information and vehicle status information to the server,
wherein the vehicle driving information comprises position information and posture information of the vehicle, and information received from other vehicle, and
wherein the vehicle status information comprises information on an operating state of a user interface device, an object detection device, a communication device for performing V2X communication, a maneuvering device, a vehicle drive device, and an operation system and information on whether each device is abnormal.

10. The driving control system of claim 5, wherein the navigation system matches an estimated section passing time received from the server to a map to display the estimated section passing time on the display.

11. The driving control system of claim 5, wherein the controller lowers a driving speed of a non-subscriber vehicle of the section service at a section occupied by the section service provider through communication between vehicles, when the controller is a controller of a subscriber vehicle registered in a section service provided by the section service provider.

12. The driving control system of claim 5, wherein the navigation system is configured to:
match a predetermined existing route and a changeable route on a map before a vehicle enters a section occupied by the section service provider to display the routes in the display; and
match a current traffic volume of the each section, the information of the section service provider, and the cost information at each of the existing route and the changeable route on a map to display the information in the display.

13. A method of controlling driving of a vehicle, the method comprising:
searching for a section occupied by a section service provider in a driving route to a destination;
determining whether the vehicle is a subscriber vehicle registered in a section service provided by the section service provider; and
having, by the subscriber vehicle, a priority in a driving speed, compared to a non-subscriber vehicle when the subscriber vehicle drives a section occupied by the section service provider.

14. The method of claim 13, further comprising:
generating, by a server, traffic volume information of each section divided at a road section of the driving route, information of a section service provider, and cost information;
matching, by a navigation system of a vehicle, the traffic volume information of each section, the information of the section service provider, and the cost information on the driving route to display the information in a display of the vehicle; and
controlling a speed of other vehicle at a section occupied by the section service provider through communication between vehicles.

15. The method of claim 14, further comprising:
storing, by the server, information of the section service provider and history management information of the section service provider in a first database; and
storing, by the server, vehicle information registered in a service of the section service provider in a second database.

16. The method of claim 14, further comprising:
transmitting vehicle information for registration of the starting point, the destination, the driving route information, and the each section service to the server through a communication device of a vehicle for performing V2X communication; and
displaying a screen for guiding subscription of the each section service in a display of the vehicle and displaying whether subscription approval of the each section service received from the server in the display.

17. The method of claim 16, further comprising transmitting a driving control request signal for controlling at least one of a speed and an advancing direction of other vehicle to the other vehicle through the communication device.

18. The method of claim 17, further comprising transmitting vehicle driving information and vehicle status information to the server,
wherein the vehicle driving information comprises position information and posture information of the vehicle and information received from other vehicle, and wherein the vehicle status information comprises information on an operating state of a user interface device, an object detection device, the communication device, a maneuvering device, a vehicle drive device, and an operation system and information on whether each device is abnormal.

19. The method of claim 16, further comprising matching an estimated section passing time received from the server to a map and displaying the estimated section passing time on the display.

20. The method of claim 16, further comprising transmitting, by a subscriber vehicle registered in a section service provided by the section service provider, a driving control request signal to a non-subscriber vehicle of the section service at a section occupied by the section service provider through communication between the vehicles to lower a driving speed of the non-subscriber vehicle.
